(19) United States
(12) Patent Application Publication
(10) Pub. No.: US 2026/0109831 A1
(43) Pub. Date: Apr. 23, 2026

(54) Apparatus for pressurizing polymer particles

(71) Applicant: FOX Velution GmbH, Burgbernheim (DE)

(72) Inventors: Jörg VETTER, Münster/Hesse (DE); Mirjam Martina LUCHT, Burgbernheim (DE); Josua Ruben SCHNEIDER, Fürth (DE)

(21) Appl. No.: 19/116,820

(22) PCT Filed: Sep. 30, 2022
(86) PCT No.: PCT/EP2022/077372

§ 371 Date: Mar. 28, 2025

(51) Int. Cl. C08J 9/18; B29C 44/34

(52) U.S. Cl. CPC C08J 9/18; B29C 44/3461

(57) ABSTRACT

An apparatus for pressurizing polymer particles with gas to generate a specific expansion capability of the polymer particles includes at least one pressure pipe including a polymer particle processing volume, wherein the at least one pressure pipe includes a length and an inner diameter, wherein the ratio of the length relative to the inner diameter is 5 or more, and wherein the inner diameter is equal or less 500 mm.

The invention relates to an apparatus for pressurizing polymer particles with gas to generate a specific expansion capability of the polymer particles.

It is known that expandable cellular polymer particles can be refined via pressurization which requires disposing the polymer particles in a pressurized atmosphere for a period of time. Disposing the polymer particles in a pressurized atmosphere results in pressurized gas penetrating into the hollow areas of the respective polymer particles, e.g. due to diffusion processes, which results in that a specific expansion behavior or expansion capability of the polymer particles is generated. The expansion behavior or expansion capability of the polymer particles enables that the polymer particles can be further processed, e.g. by a second expansion for bulk density reduction, or by molding to manufacture particle foam parts.

A respective pressurization of polymer particles is typically done in large autoclaves which can be pressurized (hereinafter referred to as “autoclave-based pressurization systems”). Respective autoclaves are filled with the polymer particles to be pressurized, set under medium to high pressure, typically also under elevated temperature, to achieve pressurization of the polymer particles to generate a specific expansion behavior or expansion capability of the polymer particles. This pressurization of the polymer particles in respective autoclaves has to be maintained over multiple hours, typically even multiple days, given that the large inner volume of respective autoclaves, which typically have inner diameters of 1,000 mm or more, requires a lot of time not only to achieve but also to maintain desired pressurizing conditions, i.e. a particularly a desired temperature level all over their complete volume, required for generating a uniform, specific expansion behavior or expansion capability of all the polymer particles.

It is therefore, an objective of the present invention to provide an improved apparatus for efficiently pressurizing polymer particles with gas to generate a specific expansion capability of the polymer particles.

The objective is achieved by the subject-matter of the independent Claims. The subject-matter of the dependent Claims refers to possible embodiments of the subject-matter of the independent Claims.

A first aspect of the invention relates to an apparatus for, particularly efficiently, pressurizing polymer particles, which polymer particles can be compact or (pre-)expanded, with gas to generate a specific expansion behavior or expansion capability of the polymer particles. The apparatus specified herein is thus, generally configured to pressurize compact or (pre-)expanded polymer particles with gas to generate a specific expansion behavior or expansion capability of the polymer particles. Pressurizing polymer particles with gas can also be deemed as loading polymer particles with gas, e.g. via solving processes, which typically applies to compact polymer particles as starting material, and/or filling cellular spaces of the polymer particles with gas, e.g. via diffusion processes, which typically applies to (pre-)expanded polymer particles as starting material. The apparatus specified herein can thus also be deemed an apparatus for producing polymer particles having a specific expansion behavior or expansion capability, respectively. Alternatively or additionally, the apparatus specified herein can be deemed an apparatus for refining polymer particles so as to provide the polymer particles with a specific expansion behavior or expansion capability, respectively relative to their original state in which they can have no expansion behavior or expansion capability, which typically applies to compact polymer particles as starting material, or in which they already have some (minor) expansion behavior or expansion capability, which typically applies to (pre-)expanded polymer particles as starting material.

Respective pressurized polymer particles having a specific expansion behavior or expansion capability, respectively typically have a cellular (inner) structure. Respective pressurized polymer particles having a specific expansion behavior or expansion capability, respectively can be deemed (pre-)expanded polymer particles.

Respective pressurized polymer particles having a specific expansion behavior or expansion capability, respectively can be further processed in at least one secondary process. A respective secondary process can be or comprise an expansion process in which respective pressurized polymer particles having a specific expansion behavior or expansion capability, respectively are further expanded, e.g. under the influence of thermal energy, particularly radiation-based thermal energy, such as infra-red radiation, or steam-based thermal energy. Alternatively or additionally, a respective secondary process can be or comprise a molding process in which respective polymer particles having a specific expansion behavior or expansion capability, respectively are molded to manufacture one or more particle foam parts.

The apparatus comprises at least one pressure pipe. The at least one pressure pipe is thus, generally configured as a pipe which implies a specific ratio of length to diameter which typically differs from the ratio of length to diameter of autoclaves as used in conventional autoclave-based pressurization systems. Particularly, the at least one pressure pipe can be configured as a longitudinal pipe, particularly as a straight pipe, having a longitudinal axis defining its length and an axial direction as well as a transverse axis defining its outer and inner diameter and a radial direction.

The at least one pressure pipe comprises a particle processing volume. The particle processing volume can be built through at least a portion of the inner volume, particularly through the entire inner volume, of the at least one pressure pipe. The inner pipe volume of the at least one pressure pipe is delimited by one or more walls of the at least one pressure pipe. In other words, the at least one pressure pipe can comprise one or more walls delimiting an inner pipe volume which can be the particle processing volume.

As indicated above, due to its longitudinal geometric configuration, the at least one pressure pipe comprises a length and an inner diameter. Notably, the ratio of the length of the at least one pressure pipe relative to the inner diameter of the at least one pressure pipe is 5 or more. Particularly, the ratio of the length of the at least one pressure pipe relative to the inner diameter of the at least one pressure pipe can be 6, 7, 8, 9, 10, 11, 12, 13, 14, 15, 16, 17, 18, 19, 20, 21, 22, 23, 24, 25, 26, 27, 28, 29, 30 or more. The aforementioned ratio values can also be threshold values of ratio intervals.

Further, the inner diameter of the at least one pressure pipe is equal or less 500 mm. Particularly, the inner diameter of the at least one pressure pipe can be equal to or less 475 mm, 450 mm, 425 mm, 400 mm, 375 mm, 350 mm, 325 mm, 300 mm, 275 mm, 250 mm, 225 mm, 200 mm, 175 mm, 150 mm, 125 mm, 100 mm, 75 mm, or 50 mm. The aforementioned inner diameter values can also be threshold values of inner diameter intervals.

As such, the at least one pressure pipe has a specific geometric configuration which differs from the geometric configuration of conventional autoclave-based pressurization systems which typically have different ratios of length to inner diameter and significantly larger inner diameters. As mentioned above, autoclaves of conventional autoclave-based pressurization systems typically have inner diameters of 1,000 mm or more.

The specific geometric configuration of the at least one pressure pipe results in diverse advantages with respect to pressurizing polymer particles to generate a specific expansion behavior or expansion capability, respectively:

One advantage of the geometric configuration of the at least one pressure pipe is that the at least one pressure pipe enables faster, easier, and thus, more efficient establishing and maintaining of desired processing conditions within the particle processing volume. This particularly, applies because the inner diameter of the at least one pressure pipe is essentially reduced relative to autoclaves of conventional autoclave-based pressurization systems which enables faster and easier achieving of desired processing conditions, i.e. particularly a desired pressure level distribution, respectively, a desired temperature level and temperature level distribution, respectively, etc., not only in the radial direction of the at least one pressure pipe but also in the axial direction of the at least one pressure pipe. In other words, not only cross-sectional areas but also the entire particle processing volume of the at least one pressure pipe can be brought faster, easier, and thus, more efficiently to desired processing conditions and kept at the same, respectively.

Another advantage of the geometric configuration of the at least one pressure pipe is that the pressure-induced mechanical loads, i.e. typically circumferential tension loads (hoop stresses), on the at least one pressure pipe are relatively low, due to the small to moderate radius, which enables that the at least one pressure pipe can have a relative low wall thickness. Particularly, the wall thickness of the at least one pressure pipe can be 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, 4.0 mm, 5.0 mm, 6.0 mm, 7.0 mm, 8.0 mm, 9.0 mm, 10.0 mm. The aforementioned wall thickness values can also be threshold values of wall thickness intervals.

As such, the at least one pressure pipe can generally be built from less mechanically stable materials, particularly standard metals, such as aluminum or standard steel, for instance relative to autoclave of conventional autoclave-based pressurization systems which require high-strength metal grades. Further, the apparatus could even be provided with standard pipes as pressure pipes which can significantly reduce production costs of the apparatus relative to usually welded autoclaves of conventional autoclave-based pressurization systems.

Another advantage of the geometric configuration of the at least one pressure pipe is that the footprint of the at least one pressure pipe is significantly smaller relative to autoclaves of conventional autoclave-based pressurization systems which not only eases installation works, service works, repair works, etc., but also facilitates installing the at least one pressure pipe in environments in which only less installation space, e.g. at the buildings inner walls, is available. Also, a given installation space can be provided with a plurality of pressure pipes in highly efficient manner.

As such, an improved apparatus for pressurizing polymer particles with gas to generate a specific expansion behavior or expansion capability, respectively of the polymer particles is given which particularly results from the specific geometric configuration of the at least one pressure pipe.

The apparatus can further comprise a polymer particle supply device configured to provide a supply stream of polymer particles, particularly an air-based, often pressurized supply stream of polymer particles, into the particle processing volume of the at least one pressure pipe. The polymer particle supply device can be arranged or built upstream of the at least one pressure pipe and can be connected to the at least one pressure pipe via one or more connection elements, such as connection pipes, connection tubes, etc.

The supply stream of polymer particles can be a pneumatic polymer particle conveying stream. A respective pneumatic polymer particle conveying stream can comprise a, particularly pressurized, conveying medium and the polymer particles to be supplied into the particle processing volume of the at least one pressure pipe. The conveying medium may be provided from a conveying medium supply. The conveying medium supply can be a gas supply or gas reservoir, respectively. The conveying medium supply can be provided through the infrastructure of a superordinate facility, such as a manufacturing facility, in which gases, e.g. compressed air, suitable for being used as a respective conveying medium are existent, for instance.

The conveying medium can be a conveying gas. The conveying gas can be air, for instance. The conveying medium may be pressurized and/or tempered. The conveying medium may comprise a pressure in the range of 1 bar to 10 bar, particularly in the range of 2 bar to 9 bar, more particularly in the range of 3 bar to 8 bar, more particularly in the range of 4 bar to 7 bar, more particularly in the range of 5 bar to 6 bar. The aforementioned pressure values can also be threshold values of pressure intervals.

The at least one polymer particle supply device can be connectable or connected to at least one polymer particle inlet opening of a polymer particle inlet section of the at least one pressure pipe. The at least one pressure pipe can thus, comprise a polymer particle inlet section comprising one or more polymer particle inlet openings through which polymer particles which are to be pressurized via the apparatus can enter the particle processing volume. The one or more polymer particle inlet openings are typically provided with a first free end, particularly an upper free end, of the at least one pressure pipe (e.g. when being arranged with its length axis parallel to a vertical axis). The one or more polymer particle inlet openings can be provided with the axial face side of the respective first free end of the at least one pressure pipe.

At least one polymer particle inlet control device can be assigned to the polymer particle inlet section, particularly the one or more polymer particle inlet openings. The polymer particle inlet control device is configured to control the amount of polymer particles streaming into the particle processing volume. The polymer particle inlet control device may be built or comprise at least one polymer particle inlet control valve device. The polymer particle inlet control valve device can comprise one or more valve elements being transferrable in at least one open state in which polymer particles can pass the polymer particle inlet control valve device and can be conveyed into the particle processing volume through the one or more polymer particle inlet openings, and in at least one closed state in which polymer particles cannot pass the polymer particle inlet control valve device and cannot be conveyed into the particle processing volume through the one or more polymer particle inlet openings.

The polymer particle inlet control device can be configured to enable a quasi-continuous or discontinuous/batch-wise operation such that polymer particles can stream into the particle processing volume in quasi-continuous or discontinuous/batch-wise manner.

The polymer particle inlet control device can comprise a hardware-and/or software-embodied control unit configured to control operation of the polymer particle inlet control device. The control unit can communicate with other control units of the apparatus and/or with a central control unit of the apparatus, the central control unit of the apparatus being configured to control operation of the apparatus. Particularly, the central control unit of the apparatus is configured to implement one or more operating modes of the apparatus examples of which will be mentioned further below.

Typically, the at least one pressure pipe also comprises a polymer particle outlet section comprising one or more polymer particle outlet openings through which pressurized polymer particles can exit the particle processing volume. The one or more polymer particle outlet openings are typically provided with a second free end, particularly a lower free end, of the at least one pressure pipe (e.g. when being arranged with its length axis parallel to a vertical axis). The one or more polymer particle outlet openings can be provided with the axial face side of the respective second free end of the at least one pressure pipe.

At least one polymer particle outlet control device can be assigned to the polymer particle outlet section, particularly the one or more polymer particle outlet openings. The polymer particle outlet control device is configured to control the amount of pressurized polymer particles streaming out of the particle processing volume after pressurization. The polymer particle outlet control device may be built or comprise at least one polymer particle outlet control valve device. The polymer particle outlet control valve device can comprise one or more valve elements being transferrable in at least one open state in which pressurized polymer particles can pass the polymer particle outlet control valve device and can be conveyed out of the particle processing volume through the one or more polymer particle outlet openings, and in at least one closed state in which pressurized polymer particles cannot pass the polymer particle outlet control valve device and cannot be conveyed out of the particle processing volume through the one or more polymer particle outlet openings.

The polymer particle outlet control device can be configured to enable a quasi-continuous or discontinuous/batch-wise operation such that polymer particles can stream out of the particle processing volume in quasi-continuous or discontinuous/batch-wise manner.

The polymer particle outlet control device can comprise a hardware- and/or software-embodied control unit configured to control operation of the polymer particle outlet control device. The control unit can communicate with other control units of the apparatus and/or with the central control unit of the apparatus mentioned above.

The at least one pressure pipe can comprise at least one double-walled section. The at least one double-walled section of the at least one pressure pipe can be built through an outer wall structure, which can be the outer wall of the at least one pressure pipe, delimiting a first inner volume of the at least one double-walled section of the at least one pressure pipe, and an inner wall structure arranged or built inside the first inner volume of the at least one pressure pipe and delimiting a second inner volume of the at least one double-walled section of the at least one pressure pipe. The first inner volume can be or delimit a cylinder- or ring-like volume (barrel jacket volume). The second inner volume can be or delimit a cylindrical volume. The first inner volume and the second inner volume communicate with each other through one or more openings, e.g. bores, slits, etc., provided with the inner wall structure. The one or more openings being sized and shaped with respect to the size and shape of the polymer particles to be processed within the particle processing volume of the at least one pressure pipe such that the polymer particles cannot penetrate from the second inner volume into the first inner volume due to their size and/or shape, particularly whilst a significant gas flow is given. The one or more openings can provide the inner wall structure with a filter-, grid- or sieve-like configuration and functionality, respectively.

The at least one double-walled section is particularly configured to separate the polymer particles from the conveying medium. As such, the at least one double-walled section can be deemed a separating unit which is configured to separate a respective supply stream of polymer particles into the conveying medium and the polymer particles. The conveying medium can exit the at least one pressure pipe via the inner wall structure with its one or more openings, the outer wall structure, and a gas outlet section of the at least one pressure pipe. The polymer particles, after being separated from the conveying medium, can fall into the at least one pressure pipe and particle processing volume, solely based on gravitational forces such that a very “soft” filling of the at least one pressure pipe and the polymer particle processing volume, respectively is possible.

The polymer particle inlet section of the at least one pressure pipe can be provided with the at least one double-walled section of the at least one pressure pipe. The double-walled section of the at least one pressure pipe can thus, be provided with a first free end, particularly an upper free end, of the at least one pressure pipe (e.g. when being arranged with its length axis parallel to a vertical axis).

The polymer particle supply device can comprise a nozzle arrangement comprising one or more nozzles, particularly Venturi nozzles. The nozzle arrangement is configured to generate a stream of polymer particles of desired properties, i.e. particularly of desired pressure, desired streaming profile, desired streaming velocity, etc. The nozzle arrangement can be arranged upstream of the polymer particle inlet control device.

The apparatus can further comprise a tempering device configured to temper, particularly heat, the polymer particles to be supplied into the particle processing volume and/or the conveying medium and/or the conveying stream of polymer particles to be supplied into the particle processing volume. The tempering device can also be configured to dry the polymer particles and/or the conveying medium and/or the conveying stream of polymer particles, respectively. The tempering device can be arranged or built upstream of the at least one pressure pipe. Particularly, the tempering device can be provided with respective connection elements, such as connection pipes, connection tubes, etc., through which the polymer particle supply device is connected to the at least one pressure pipe. The tempering device can comprise one or more tempering elements, such as electrical heating elements, for instance whose operation can be controlled via a hardware- and/or software-embodied control unit of the tempering device.

The apparatus can further comprise a pressure supply device configured to supply a pressurized gas into the particle processing volume of the at least one pressure pipe. The pressure supply device can be connected to a gas inlet section of the at least one pressure pipe. The gas inlet section of the at least one pressure pipe can comprise one or more gas inlet openings. The pressure supply device can be connected to the at least one pressure pipe via one or more connection elements, such as connection pipes, connection tubes, etc. The pressurized gas can be air, which is typically applied for (pre-)expanded polymer particles, or carbon dioxide, which is typically applied for compact polymer particles, for instance. The pressurized gas can also be a mixture of at least two gases in any case. The pressurized gas may be provided from a pressurized gas supply. The pressurized gas supply can thus, be a gas supply or gas reservoir, respectively. The pressurized gas supply can be provided through the infrastructure of a superordinate facility, such as a manufacturing facility, in which pressurized gases suitable for being used as a respective pressurized gas are existent.

The pressurized gas supplyable or supplied by the pressure supply device can have an absolute pressure above 1 bar, which is ambient pressure. Particularly, the pressurized gas can have an absolute pressure of 2 bar, 3 bar, 4 bar, 5 bar, 6 bar, 7 bar, 8 bar, 9 bar, 10 bar, 11 bar, 12 bar, 13 bar, 14 bar, 15 bar, 16 bar, 17 bar, 18 bar, 19 bar, 20 bar, 21 bar, 22 bar, 23 bar, 24 bar, 25 bar, 26 bar, 27 bar, 28 bar, 29 bar, 30 bar, 31 bar, 32 bar, 33 bar, 34 bar, 35 bar, 36 bar, 37 bar, 38 bar, 39 bar, 40 bar, 41 bar, 42 bar, 43 bar, 44 bar, 45 bar, 46 bar, 47 bar, 48 bar, 49 bar, 50 bar. The aforementioned pressure values can also be threshold values of pressure intervals.

As such, the pressure inside the particle processing volume, at least during operation of the at least one pressure pipe in a pressurizing mode, can also be above 1 bar, thus above ambient pressure. The aforementioned pressure levels of the pressurized gas supplyable or supplied by the pressure supply device can correspond to the pressure levels within the particle processing volume of the at least one pressure pipe at least during operation of the apparatus in a pressurizing mode.

At least one gas inlet control device can be assigned to the gas inlet section of the at least one pressure pipe, particularly the one or more gas inlet openings of the gas inlet section. The gas inlet control device is configured to control the amount of pressurized gas streaming into the particle processing volume. The gas inlet control device may be built or comprise at least one gas inlet control valve device. The gas inlet control valve device can comprise one or more valve elements being transferrable in at least one open state in which pressurized gas can pass the gas inlet control (valve) device and can stream into the particle processing volume through the one or more gas inlet openings, and in at least one closed state in which pressurized gas cannot pass the gas inlet control (valve) device and cannot stream into the particle processing volume through the one or more gas inlet openings.

The gas inlet control device can be configured to enable a continuous, quasi-continuous or discontinuous operation such that pressurized gas can stream into the particle processing volume in continuous, quasi-continuous or discontinuous manner.

The gas inlet control device can comprise a hardware- and/or software-embodied control unit configured to control operation of the gas inlet control device. The control unit can communicate with other control units of the apparatus and/or with the central control unit of the apparatus mentioned above.

The gas inlet section of the at least one pressure pipe can also be provided with the at least one double-walled section of the at least one pressure pipe. Particularly, the gas inlet section can be provided adjacent to the polymer particle inlet section. As indicated above, the polymer particle inlet section is typically provided at the first free end of the at least one pressure pipe.

The apparatus can further comprise a tempering device configured to temper, particularly heat, the pressurized gas to be supplied to the at least one pressure pipe. The tempering device can also be configured to dry the pressurized gas. The tempering device can be provided with respective connection elements, such as connection pipes, connection tubes, etc., through which the pressure supply device is connected to the at least one pressure pipe. The tempering device can comprise one or more tempering elements, such as electrical heating elements, for instance.

As indicated further above, the at least one pressure pipe can further comprise a gas outlet section. The gas outlet section can comprise one or more gas outlet openings through which gas, such as a, particularly pressurized, gaseous conveying medium of a supply stream of polymer particles, can exit the particle processing volume e.g. in a filling mode of the apparatus in which the particle processing volume is filled with polymer particles which are to be pressurized. A respective gas outlet section can be provided at a first free end, i.e. typically an upper end, of the at least one pressure pipe. A respective first free end of the at least one pressure pipe can be the end of the at least one pressure pipe which comprises the polymer particle inlet section.

At least one gas outlet control device can be assigned to the gas outlet section, particularly the one or more gas outlet openings of the gas outlet section. The gas outlet control device is configured to control the amount of gas streaming out of the at least one pressure pipe e.g. in a respective filling mode of the apparatus. The gas outlet control device may be built or comprise at least one gas outlet control valve device. The gas outlet control valve device can comprise one or more valve elements being transferrable in at least one open state in which gas can pass the gas outlet control (valve) device and can stream out of the at least one pressure pipe through the one or more gas outlet openings, and in at least one closed state in which gas cannot pass the gas outlet control (valve) device and cannot stream out of the at least one pressure pipe through the one or more gas outlet openings.

The gas outlet control device can be configured to enable a continuous, quasi-continuous or discontinuous operation such that gas can stream out of the at least one pressure pipe in continuous, quasi-continuous or discontinuous manner.

The gas outlet control device can comprise a hardware- and/or software-embodied control unit configured to control operation of the gas outlet control device. The control unit can communicate with other control units of the apparatus and/or with a central control unit of the apparatus mentioned above.

The gas outlet section of the at least one pressure pipe can also be provided with the at least one double-walled section of the at least one pressure pipe. Particularly, the gas outlet section can be provided adjacent to the polymer particle inlet section. More particularly, the gas outlet section can be provided in between the polymer particle inlet section and the gas inlet section. As indicated above, the polymer particle inlet section is typically provided at the first free end of the at least one pressure pipe. Providing the gas outlet section with the double-walled section of the at least one pressure pipe assures that only gas and no polymer particles can exit the at least one pressure pipe through the gas outlet section and the respective gas outlet openings, respectively.

The gas inlet section and the or a respective gas outlet section of the at least one pressure pipe can co-act to control or regulate pressurization of the at least one pressure pipe and the particle processing volume, respectively. A respective control or regulation of pressurization of the at least one pressure pipe and the particle processing volume, respectively can be effected by an alternating operation of the at least one gas inlet control device and the at least one gas outlet control device, respectively. Particularly, a respective control or regulation of pressurization of the at least one pressure pipe and the particle processing volume can comprise a first step which comprises opening the at least one gas inlet control device for a specific time such that pressurized gas can stream into the particle processing volume thereby, increasing the pressure inside the particle processing volume about a certain amount, e.g. to reach a first (upper) threshold pressure, while the at least one gas outlet control device is closed, and a second step which comprises closing the at least one gas inlet control device such that no pressurized gas can stream into the particle processing volume and opening the at least one gas outlet control device for a specific time such that pressurized gas can stream out of the particle processing volume thereby, decreasing the pressure inside the particle processing volume about a certain amount, e.g. to reach a second (lower) threshold pressure. By operating the at least one gas inlet control device and the at least one gas outlet control device to alternatingly implement the two steps, a reliable control and regulation of the pressure inside the at least one pressure pipe and the particle processing volume, respectively is feasible. A respective alternating operation of the at least one gas inlet control device and the at least one gas outlet control device can be effected through the central control unit, for instance.

The apparatus can further comprise a dampening device, particularly an acoustic dampening device, connectable or connected to the gas outlet section and configured to dampen, i.e. particularly decompress, a pressurized gas stream exiting the at least one pressure pipe through the gas outlet section. The dampening device can comprise a dampening structure comprising one or more dampening elements, such as dampening walls, enabling dampening noise originating from gas streaming out of the at least one pressure pipe through the one or more gas outlet openings of the gas outlet section. The dampening device can be arranged or built upstream of the gas outlet control device.

The apparatus can further comprise a heating device configured to heat the particle processing volume of the at least one pressure pipe. Heating the particle processing volume and thus, the polymer particles filled therein can significantly improve efficiency of the pressurizing process of the polymer particles. As explained above, the at least one pressure pipe can, due to its special geometric configuration, enable a faster achievement of desired processing conditions, such as a desired temperature level and temperature level distribution, respectively, etc., not only in the radial direction of the at least one pressure pipe but also in the axial direction of the at least one pressure pipe. In other words, not only cross-sectional areas but also the entire particle processing volume of the at least one pressure pipe can be brought faster, easier, and thus, more efficiently to a desired temperature level and kept at the same, respectively. The heating device can particularly, be configured to heat the particle processing volume to a temperature in the range between 10-100° C., particularly in the range between 30-80° C.; more particularly in the range between 50-60° C. Typically, the temperature will be selected under consideration of the properties of the polymer particles to be pressurized, i.e. particularly under consideration of at least one of the softening temperature, the glass transition temperature, or the melting temperature.

The heating device can be configured to generate a plurality of temperature zones having same or different temperatures within the particle processing volume. As such, a highly individualized temperature control of the particle processing volume can be implemented. As indicated above, a respective temperature control typically, aims at a constant temperature level and/or temperature distribution throughout the entire particle processing volume of the at least one pressure pipe to ensure consistent pressurization of the polymer particles and thus, loading of the polymer particles with gas irrespective of their location within the particle processing volume.

The heating device can comprise a hardware- and/or software embodied control device to control operation of the heating device. The control unit can communicate with other control units of the apparatus and/or with the central control unit of the apparatus mentioned above.

The control unit of the heating device can particularly be configured to control operation of the heating device such that a specific temperature or temperature distribution, e.g. a constant temperature or constant temperature distribution, is provided inside the at least one pressure pipe, particularly inside the particle processing volume, particularly during pressurization of polymer particles inside the particle processing volume. Particularly, the control unit of the heating device can be configured to control operation of the heating device such that specific temperature profiles within the particle processing volume are created, adjusted, or maintained. A respective constant temperature can be e.g. a temperature in the range of 20-50° C., particularly 20-30° C., to assure stable process conditions (despite a cold ambient temperature). Respective temperature profiles can e.g. compensate for possible convection and/or diffusion effects, promote the ability to solve gas within the polymer particles, promote the ability to diffuse gas into the polymer particles. Respective temperatures profiles can be material- and/or process-specific such that each material and/or process can be processed/implemented its own temperature profile.

The heating device can comprise one or more heating elements. The one or more heating elements can be arranged at different locations of the at least one pressure pipe, particularly on the outer surface of the at least one pressure pipe, and/or one can extend in different directions along the at least one pressure pipe, particularly on the outer surface of the at least one pressure pipe. Each heating element can be assigned to a specific temperature zone of the at least one pressure pipe. Each heating element can comprise an electric heating element and/or a heating channel element through which a heating medium may stream, for instance.

The at least one pressure pipe can be at least partially, particularly completely, surrounded by at least one thermal insulation element. The at least one thermal insulation element enables an efficient temperature control within the particle processing volume because it avoids or reduces undesired temperature losses which also results in an improved energy efficiency of the apparatus. The at least one thermal insulation element can be made from a thermally insulating material, such as e.g. glass fibers, mineral fibers, plastic foams, etc., and/or form a thermally insulating material structure, e.g. a glass textile structure, mineral fiber textile structure, plastics foam structure, etc.

The apparatus can comprise one more sensor elements configured to sense chemical and/or physical quantities of the at least one pressure pipe and/or of one or more of the aforementioned devices of the apparatus. Respective sensor elements can thus, be mounted on or in the at least one pressure pipe, particularly within the particle processing volume. Alternatively or additionally, respective sensor elements can thus, be mounted on or in the polymer particle supply device and/or the pressure supply device and/or the polymer particle inlet control device and/or the polymer particle outlet control device and/or the gas outlet control device and/or the gas inlet control device and/or respective connection elements, such as connection pipes, connection tubes, etc.

Particularly, the apparatus can comprise one more sensor elements configured to sense chemical and/or physical quantities within the particle processing volume during one or more operating modes of the apparatus. Respective sensor information can be used to control operation of the apparatus, e.g. to implement a sensor-information-based control loop, during one or more operating modes of the apparatus.

As a concrete example, the apparatus can comprise one or more pressure sensors or pressure detection devices configured to detect the pressure level in the particle processing volume. Respective pressure values can, particularly together with other one or more other sensor values, be used by respective control units for controlling operation of the apparatus.

As another concrete example, the apparatus can comprise one or more temperature sensors or temperature detection devices configured to detect the temperature level on or in the particle processing volume. Respective temperature values can, particularly together with one or more other sensor values, be used by respective control units for controlling operation of the apparatus.

It has been mentioned above that the apparatus is operable and can thus, be operated in one or more operating modes. Non-limiting examples of respective operating modes of the apparatus are set forth in the following:

The apparatus can be operable in a filling mode in which the particle processing volume is fillable or filled with polymer particles which are to be pressurized to generate a specific expansion behavior or expansion capability, respectively. The implementation of a respective filing mode can be effected through a hardware- and/or software-embodied central control unit of the apparatus. The central control unit can communicate with one or more devices of the apparatus required for enabling the filling mode. In the filling mode, which can comprise continuous, quasi-continuous or discontinuous (stepwise) filling of the particle processing volume with polymer particles which are to be pressurized, one or more of the following processes can be implemented in series or in parallel.

The polymer particle supply device supplies polymer particles into the particle processing volume of the at least one pressure pipe so as to fill the particle processing volume with polymer particles which are to be pressurized. Typically, the particle processing volume is completely filled with polymer particles which are to be pressurized. Thus, the polymer particle inlet control device enables filling the particle processing volume with polymer particles. As such, the one or more polymer particle inlet control valve devices are in an open state. Particularly, respective one or more valve elements are transferred in their respective at least one open state in which polymer particles which are to be pressurized can pass the one or more control valve devices and can be conveyed into the particle processing volume.

Typically, the gas outlet control device (if present) enables removing gas through the gas outlet section in the filling mode. As such, the one more gas outlet control valve devices are in an open state in the filling mode. Particularly, respective one or more valve elements are transferred in their respective at least one open state in which gas can pass the one or more gas outlet control valve devices and can stream out of the particle processing volume through the one or more gas outlet openings. As such, the filling of the particle processing volume with polymer particles which are to be pressurized can be effected or at least supported by gravity forces. Particularly, the particle processing volume can simply be filled by having the polymer particles fall into it.

Optionally, the polymer particle outlet control device enables filling the particle processing volume with polymer particles which are to be pressurized. As such, the one or more polymer particle outlet control valve devices can be in a closed state in the filling mode. Particularly, respective one or more valve elements are transferred in their respective at least one closed state in which polymer particles cannot pass the one or more polymer particle outlet control valve devices and cannot be conveyed out of the particle processing volume through the one or more polymer particle outlet openings.

Another exemplary operating mode of the apparatus is a pressurizing mode in which the particle processing volume and the polymer particles filled therein are set under pressure. The pressurizing mode can comprise continuous, quasi-continuous or discontinuous (stepwise) pressurization of the particle processing volume and the polymer particles filled therein. The implementation of the pressurizing mode can be effected through the hardware- and/or software-embodied central control unit of the apparatus. The central control unit can communicate with one or more devices of the apparatus required for enabling the pressurizing mode. In the pressurizing mode the one or more of the following processes can be implemented in series or in parallel:

The polymer particle inlet control device enables pressurizing the particle processing volume and the polymer particles filled therein. As such, the one or more polymer particle inlet control valve devices are typically in a closed state. Particularly, respective one or more valve elements are transferred in their respective at least one closed state in which polymer particles cannot pass the one or more polymer particle inlet control valve devices and cannot be conveyed out of the particle processing volume through the one or more polymer particle inlet openings.

The one or more polymer particle inlet control valve devices can be transferred in the open state for re-pressurization of the particle processing volume at least at one or more specific times during the pressurizing mode. Particularly, respective one or more valve elements can be transferred in their respective at least one open state such that pressurized gas, e.g. supplied from a pressurized gas reservoir of the apparatus, can pass the one or more polymer particle inlet control valve devices and can be supplied into the particle processing volume. As such, the one or more polymer particle inlet control devices can also be used for supplying a pressurized gas into the particle processing volume at one or more specific times during the pressurizing mode to implement or maintain a desired, particularly material-specific, pressure level inside the particle processing volume during pressurization of the polymer particles. Respective times can comprise cyclic or regular time intervals or anti-cyclic or irregular time intervals.

Optionally, the gas outlet control device does not enable removing gas through the gas outlet section of the at least one pressure pipe in the pressurizing mode. As such, the one or more gas outlet control valve devices are in a closed state. Particularly, respective one or more valve elements are transferred in their respective at least one closed state in which gas cannot pass the one or more gas outlet control valve devices and cannot stream out of the particle processing volume through the one or more gas outlet openings.

Optionally, the polymer particle outlet control device enables pressurizing the particle processing volume and the polymer particles filled therein in the pressurizing mode. As such, the one or more polymer particle outlet control valve devices are in a closed state in the pressurizing mode. Particularly, respective one or more valve elements are transferred in their respective at least one closed state in which polymer particles cannot pass the one or more polymer particle outlet control valve devices and cannot be conveyed out of the particle processing volume through the one or more polymer particle outlet openings.

The pressure supply device enables pressurizing the particle processing volume and the polymer particles filled therein in the pressurizing mode. As such, the one or more gas inlet control devices are at least in an initial state of the pressurizing mode in an open state. Particularly, respective one or more valve elements are transferred in their respective at least one open state in which pressurized gas can pass the one or more gas inlet control devices and can be supplied into the particle processing volume through the gas inlet openings.

The constructive and/or functional configuration of the at least one pressure pipe can enable that an overfilling of the polymer particle processing volume is not possible because an inverse stream of polymer particles will be automatically generated inside the at least one pressure pipe above a certain threshold filling level. A respective inverse stream will effect that the conveying medium, typically including polymer particles, will change its streaming direction inside the polymer particle processing volume and effectively stream in inversed direction towards the polymer particle inlet section because the conveying medium cannot exit the at least one pressure pipe via the at least one gas outlet section due to the (high) filling level which obstructs the conveying medium from exiting the at least one pressure pipe via the at least one gas outlet section. As such, a self-regulatory filling mode is feasible which does typically not require separate fill-level sensors which oftentimes provide only non-satisfying fill-level information.

Another exemplary operating mode of the apparatus is a de-filling mode (emptying mode) in which the pressurized polymer particles are de-filled (emptied) from the particle processing volume. The de-filling mode can comprise continuous, quasi-continuous or discontinuous de-filling of the particle processing volume. The implementation of the de-filling mode can be effected through the hardware- and/or software-embodied central control unit of the apparatus. The central control unit can communicate with one or more devices of the apparatus required for enabling the de-filling mode. In the de-filling mode one or more of the following processes can be implemented in series or in parallel:

The polymer particle supply device does typically not supply polymer particles into the particle processing volume in the de-filling mode. Thus, the polymer particle inlet control device enables de-filling the particle processing volume through the one or more polymer particle outlet openings. As such, the one or more polymer particle inlet control valve devices are typically in a closed state. Particularly, respective one or more valve elements are typically transferred in their respective at least one closed state in which polymer particles cannot pass the one or more polymer particle inlet control valve devices and cannot be conveyed into the particle processing volume through the one or more polymer particle inlet openings.

Optionally, also the gas outlet control (if present) device enables de-filling the particle processing volume through the one or more polymer particle outlet openings in the de-filling mode. As such, the one more gas outlet control valve devices are typically in a closed state. Particularly, respective one or more valve elements are transferred in their respective at least one closed state in which gas cannot pass the one or more gas outlet control valve devices and cannot stream out of the particle processing volume through the one or more gas outlet openings.

The polymer particle outlet control device enables de-filling the particle processing volume to remove polymer particles through the one or more polymer particle outlet openings in the de-filling mode. As such, the one or more polymer particle outlet control devices are in an open state. Particularly, respective one or more valve elements are transferred in their respective at least one open state in which pressurized polymer particles can pass the one or more polymer particle outlet control devices and can be conveyed out of the particle processing volume through the one or more polymer particle outlet openings.

As such, also de-filling of the particle processing volume can be effected or at least supported through gravity forces. Particularly, the particle processing volume can simply be de-filled by having the pressurized polymer particles fall through the one or more polymer particle outlet openings.

The apparatus can also be configured to implement a cleaning mode in which cleaning of the particle processing volume of the at least one pressure pipe is possible. Cleaning may particularly comprise removing residual polymer particles from the particle processing volume which can e. g. be required when polymer particles having different chemical and/or physical properties relative to previously processed polymer particles are to be pressurized. The implementation of the cleaning mode can be effected through the hardware- and/or software-embodied central control unit of the apparatus. The central control unit can communicate with one or more devices of the apparatus required for enabling the cleaning mode. In the cleaning mode, which can comprise continuous, quasi-continuous or discontinuous cleaning of the particle processing volume, one or more of the following processes can be implemented in series or in parallel:

In the cleaning mode, the polymer particle supply device does typically not supply polymer particles into the particle processing volume. Yet, the polymer particle inlet control device enables supplying a continuous, quasi-continuous or discontinuous stream of cleaning fluid, e.g. a pressurized cleaning gas, such as pressurized air, into the particle processing volume of the at least one pressure pipe through the one or more polymer particle inlet openings. As such, the one or more polymer particle inlet control valve devices are typically in an open state. Particularly, respective one or more valve elements are typically transferred in their respective at least one open state in which a stream of cleaning fluid can pass the one or more polymer particle inlet control valve devices and can stream into the particle processing volume through the one or more polymer particle inlet openings.

Optionally, the gas outlet control device enables cleaning the particle processing volume with a respective stream of a cleaning fluid in the cleaning mode. As such, the one more gas outlet control devices are typically in a closed state. Particularly, respective one or more valve elements are transferred in their respective at least one closed state in which gas cannot pass the one or more gas outlet control valve devices and cannot stream out of the particle processing volume through the one or more gas outlet openings.

Typically, also the polymer particle outlet control device enables cleaning the particle processing volume with a respective stream of a cleaning fluid. As such, the one or more polymer particle outlet control valve devices are in an open state in the cleaning mode. Particularly, respective one or more valve elements are transferred in their respective at least one open state in which the stream of cleaning fluid can pass the one or more polymer particle outlet control valve devices and can stream out of the particle processing volume through the one or more polymer particle outlet openings.

As such, cleaning of the particle processing volume can be effected by one or more streams of cleaning gas streaming through the particle processing volume. The one or more streams of cleaning gas typically, enter the particle processing volume via the more polymer particle inlet openings and exit the particle processing volume via the one or more polymer particle outlet openings. As such, the one or more streams of cleaning gas typically stream through the entire particle processing volume, particularly through the entire cross-section of the particle processing volume, thereby removing undesired residues, such as polymer particle residues, resulting in an efficient and thorough cleaning of the particle processing volume. Further, a chemical and/or physical conditioning of the particle processing volume can be effected, particularly when the cleaning gas has specific chemical and/or physical properties, such as a specific chemical composition, a specific temperature, etc.

A respective stream of cleaning gas can be provided as one or more distinct pressure boosts, pressure impulses, or pressure waves, respectively. Respective pressure boosts, pressure impulses, or pressure waves can have a pressure between 5 and 25 bar, particularly between 10 and 15 bar, for instance.

For enabling a respective cleaning mode, the apparatus can comprise a cleaning device configured to generate or provide at least one stream of cleaning fluid, such as a pressurized cleaning gas. The cleaning device can be arranged or built upstream of the at least one pressure pipe and can be connected to the at least one pressure pipe via one or more connection elements, such as connection pipes, connection tubes, etc. Particularly, the cleaning device can be arranged or provided upstream of the one or more polymer particle inlet control devices.

One, more, or all of the above-specified exemplary operating modes of the apparatus can also be implemented when the apparatus comprises multiple pressure pipes, particularly in a parallel arrangement.

In an exemplary configuration of the apparatus with multiple pressure pipes, the following operation of the apparatus is conceivable and can be effected e.g. via the or a central hardware- and/or software-embodied control unit of the apparatus:

A first pressure pipe can be operated in a filling mode in a time interval between a first time t1 and a second time t2. After filling mode is completed, the first pressure pipe can be operated in a pressurizing mode in a time interval between a third time t3 and a fourth time t4. Notably, the third time t3 can be the same as the second time t2 or can be after the second time t2. After pressurizing mode is completed, the first pressure pipe can be operated in a de-filling mode in a time interval between a fifth time t5 and a sixth time t6. Notably, the fifth time t5 can be the same as the fourth time t4 or can be after the fourth time t4. The filling, pressurization, and de-filling of the first pressure pipe can be deemed a first operating cycle of the first pressure pipe. After a respective first operating cycle is completed, i.e. after completing the de-filling mode at the time t6, one or more further operating cycles of the first pressure pipe can be conducted in same or similar manner.

The same applies when the first operating cycle further comprises implementing a cleaning mode after completion of the de-filling mode. The implementation of a cleaning mode after completion of the de-filling mode can be required when chemically and/or physically different polymer particles are to be processed in the first pressure pipe, for instance. In this case, the first pressure pipe would be operated in a cleaning mode in a time interval between a seventh time t7 and an eighth time t8. Notably, the seventh time t7 can be the same as the sixth time t6 or can be after the sixth time t6. Again, after a respective first operating cycle which also includes a respective cleaning mode is completed, i.e. after completing the cleaning mode at the time t8, one or more further operating cycles of the first pressure pipe can be conducted in same or similar manner.

Also at least one further pressure pipe can be operated in respective operating cycles. The operating cycles of the at least one further pressure pipe can implement the same start times and end times for their respective operating modes as the first pressure pipe and can thus, also have the same duration for their respective operating modes as the first pressure pipe. Thus, the filling mode (and the subsequent modes) of a second pressure pipe can start at the same time as the filling mode (and the subsequent modes) of a first pressure pipe and can have the same duration (which particularly, applies for pressure pipes of the same functional and constructive configuration). This also means that the overall duration of an operating cycle of a second pressure pipe can be the same as the overall duration of an operating cycle of a first pressure pipe, or vice versa.

However, it is also conceivable that the operating cycles of two pressure pipes can be shifted in time which means that an operating cycle of a second pressure pipe starts with a specific time delay after the start of the operating cycle of a first pressure pipe. Thus, e.g. the filling mode (and the subsequent modes) of a second pressure pipe can start with a specific time delay relative to the filling mode (and the subsequent modes) of a first pressure pipe such that, given that the respective modes have the same duration (which particularly, applies for pressure pipes of the same functional and constructive configuration), the first operating cycle of the second pressure pipes also ends with the respective time delay relative to the operating cycle of the first pressure pipe.

Applying this principle of operating multiple pressure pipes with timely shifted operating cycles can result in that the apparatus provides for a continuous or quasi-continuous output of pressurized polymer particles which can result in a significant increase of efficiency of post-processing or post-production, respectively compared with conventional autoclave-based pressurizing systems. This particularly, applies when considering the smaller space (footprint) required for installation of respective pressure pipes compared with conventional autoclave-based pressurizing systems. This also applies, when considering the cumbersome cleaning of conventional autoclave-based pressurizing systems which can require hours of cleaning effort.

It is clear from the above explanation that the at least one pressure pipe can be vertically oriented arranged. In a vertically oriented arrangement, the length axis of the at least one pressure pipe extends (essentially) parallel to a vertical axis which enables the use of gravity forces for filling and/or de-filling of the particle processing volume of the at least one pressure pipe.

However, an inclined oriented arrangement of the at least one pressure pipe is also possible. In an inclined oriented arrangement, the length axis of the at least one pressure pipe extends inclined to a vertical axis which typically still enables the use of gravity forces for filling and/or de-filling of the particle processing volume if the at least one pressure pipe. As such, the inclination angle of the length axis of the at least one pressure pipe relative to a vertical axis can be in the range of 1 to 75°, more particularly in the range of 1 to 65°, more particularly in the range of 1 to 55°, more particularly in the range of 1 to 45°, more particularly in the range of 1 to 35°, more particularly in the range of 1 to 25°, more particularly in the range of 1 to 15°, more particularly in the range of 1 to 5°, relative to a vertical axis.

In a configuration of the apparatus with multiple pressure pipes, the inclined parallel arrangement of pressure pipes can result in an optimized use of an available installation space relative to the total available particle processing volume.

As such, in a configuration of the apparatus with multiple pressure pipes, two, more than two or all of the multiple pressure can be arranged in parallel.

It is also clear from the above that the at least one pressure pipe typically, comprises one or more mounting interfaces for mounting the at least one pressure pipe e.g. to a wall, particularly a vertically extending wall, or any other mounting structure, such as a rack, shelve, etc., of a given infrastructure. Mounting the at least one pressure pipe to a wall or any other mounting structure can enable the vertical or inclined arrangement specified further above. Respective mounting interfaces provided with the at least one pressure pipe can, e.g., be or comprise mechanical interfaces which enable a detachable attachment of the at least one pressure pipe.

One benefit of the constructive and/or functional design of the apparatus is that the apparatus can be classified either to risk class 1 or 2 with regards to official regulations such as the European pressure equipment directive, for instance. This is applicable for certified pipes with a certain range of the working pressure pw multiplied by nominal inner diameter DN (e.g. DN_{max.}≤250 mm @ p_{w}≤13 bar). This means that the apparatus does not necessarily have to be subject to any official/external certification neither before installing it nor during its life time as opposed to conventional autoclaves.

A second aspect of the invention relates to a system for pressurizing and processing polymer particles. The system comprises an apparatus of the first aspect of the invention and at least one processing device for further processing the polymer particles, which have been pressurized via the apparatus, in a secondary process. Thus, the processing device is typically arranged downstream of the apparatus and can be connected to the apparatus through one or more connection elements, connection pipes, connection tubes, etc., and/or conveying elements, such as conveyor bands, etc. As indicated above, a respective secondary process can be or comprise an expansion process in which respective polymer particles having a specific expansion behavior or expansion capability, respectively are further expanded, e.g. under the influence of thermal energy, particularly radiation-based thermal energy, such as infra-red radiation, or steam-based thermal energy, and/or a molding process in which respective polymer particles having a specific expansion behavior or expansion capability, respectively are molded to manufacture one or more particle foam parts.

A third aspect of the invention relates to a method for pressurizing polymer particles with gas to generate a specific expansion behavior or expansion capability, respectively of the polymer particles. The method is implemented by an apparatus of the first aspect of the invention.

The method can comprise the steps of filling the particle processing volume of at least one pressure pipe with polymer particles and pressurizing the polymer particles in the particle processing volume for a specific time so as to obtain pressurized polymer particles having a specific expansion capability.

The method can particularly, comprise implementing one or more of the operating modes of the apparatus as specified above.

The method can thus, be implemented via the central control unit of the apparatus as mentioned above.

Generally, all remarks relating to the apparatus of the first aspect of the invention also apply to the system of the second aspect of the invention and/or to the method of the third aspect of the invention.

The invention is further specified in accordance with the attached drawings, which comprise:

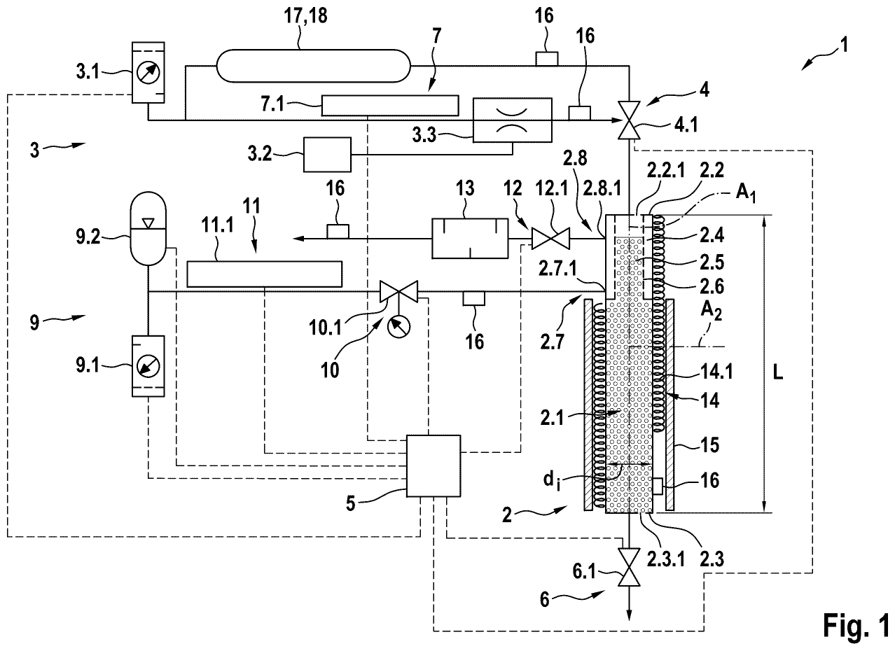

FIG. 1-3 each of which is a schematic drawing of an apparatus according to an exemplary embodiment; and

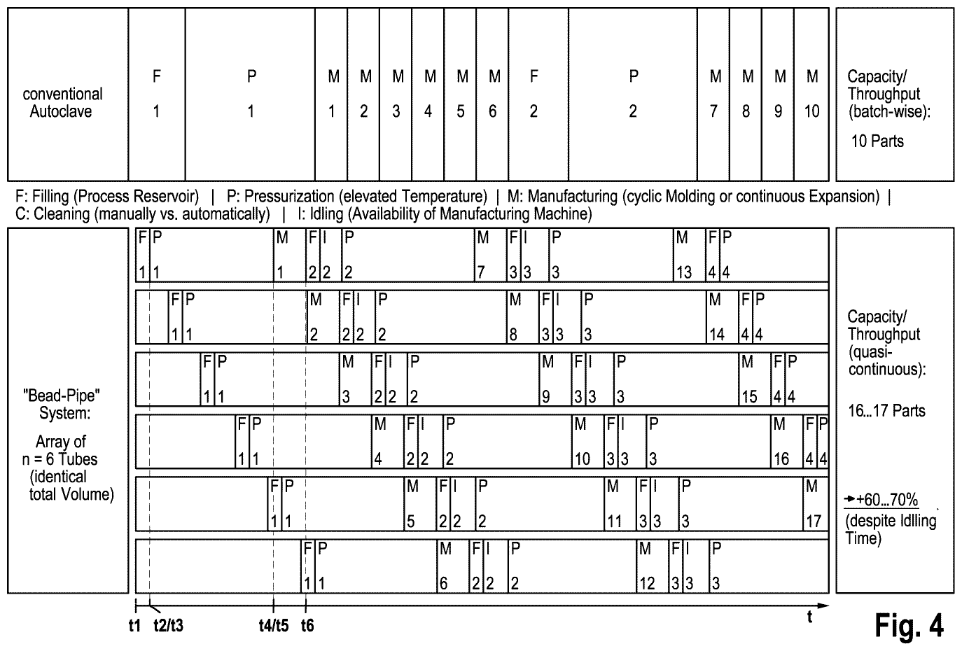

FIG. 4-6 each of which is a scheme of implementing operating modes of an apparatus according to an exemplary embodiment.

FIG. 1 is a schematic drawing of an apparatus 1 for pressurizing polymer particles, which polymer particles can be compact or (pre-)expanded, with gas to generate a specific expansion behavior or expansion capability of the polymer particles according to an exemplary embodiment. The apparatus 1 is thus, generally configured to pressurize compact or (pre-)expanded polymer particles with gas to generate a specific expansion behavior or expansion capability of the polymer particles. Pressurizing polymer particles with gas can also be deemed as loading polymer particles with gas, e.g. via solving processes, which typically applies to compact polymer particles as starting material, and/or filling cellular spaces of the polymer particles with gas, e.g. via diffusion processes, which typically applies to (pre-)expanded polymer particles as starting material. The apparatus 1 can thus also be deemed an apparatus for producing polymer particles having a specific expansion behavior or expansion capability, respectively, or as an apparatus for refining polymer particles so as to provide the polymer particles with a specific expansion behavior or expansion capability, respectively relative to their original state in which they can have no expansion behavior or expansion capability, which typically applies to compact polymer particles as starting material, or in which they already have some (minor) expansion behavior or expansion capability, which typically applies to (pre-)expanded polymer particles as starting material.

Respective pressurized polymer particles produced by the apparatus 1 and thus, having a specific expansion behavior or expansion capability, respectively can be further processed in at least one secondary process. A respective secondary process can be or comprise an expansion process in which respective pressurized polymer particles having a specific expansion behavior or expansion capability, respectively are further expanded, e.g. under the influence of thermal energy, particularly radiation-based thermal energy, such as infra-red radiation, or steam-based thermal energy. Alternatively or additionally, a respective secondary process can be or comprise a molding process in which respective polymer particles having a specific expansion behavior or expansion capability, respectively are molded to manufacture one or more particle foam parts.

The apparatus 1 comprises a pressure pipe 2. The at least one pressure pipe 2 is thus, generally configured as a pipe which implies a specific ratio of length to diameter which typically differs from the ratio of length to diameter of autoclaves as used in conventional autoclave-based pressurization systems. As is apparent from FIG. 1, the pressure pipe 2 can be configured as a longitudinal pipe, particularly as a straight pipe, having a longitudinal axis A₁ defining its length L and an axial direction as well as a transverse axis A₂ defining its outer and inner diameter di and a radial direction.

As is apparent from FIG. 1, the pressure pipe 2 comprises a particle processing volume 2.1. The particle processing volume 2.1 can be built through at least a portion of the inner volume of the pressure pipe 2 which is delimited by one or more walls of the pressure pipe 2.

As indicated above, due to its longitudinal geometric configuration, the pressure pipe 2 comprises a length L and an inner diameter dᵢ. Notably, the ratio of the length L of the pressure pipe relative to the inner diameter dᵢ of the pressure pipe 2 is 5 or more. Particularly, the ratio of the length L of the pressure pipe relative to the inner diameter dᵢ of pressure pipe 2 can be 6, 7, 8, 9, 10, 11, 12, 13, 14, 15, 16, 17, 18, 19, 20, 21, 22, 23, 24, 25, 26, 27, 28, 29, 30 or more. The aforementioned ratio values can also be threshold values of ratio intervals.

Further, the inner diameter dᵢ of the pressure pipe 2 is equal or less 500 mm. Particularly, the inner diameter dᵢ of the pressure pipe 2 can be equal to or less 475 mm, 450 mm, 425 mm, 400 mm, 375 mm, 350 mm, 325 mm, 300 mm, 275 mm, 250 mm, 225 mm, 200 mm, 175 mm, 150 mm, 125 mm, 100 mm, 75 mm, or 50 mm. The aforementioned inner diameter values can also be threshold values of inner diameter intervals.

As such, the pressure pipe 2 has a specific geometric configuration which differs from the geometric configuration of conventional autoclave-based pressurization systems which typically have different ratios of length to inner diameter and significantly larger inner diameters. As mentioned above, autoclaves of conventional autoclave-based pressurization systems typically have inner diameters of 1,000 mm or more.

The specific geometric configuration of the pressure pipe 2 results in diverse advantages with respect to pressurizing polymer particles to generate a specific expansion behavior or expansion capability, respectively.

One advantage of the geometric configuration of the pressure pipe 2 is that the pressure pipe 2 enables faster, easier, and thus, more efficient establishing and maintaining of desired processing conditions within the particle processing volume 2.1. This particularly, applies because the inner diameter di of the pressure pipe 2 is essentially reduced relative to autoclaves of conventional autoclave-based pressurization systems which enables faster and easier achieving of desired processing conditions, i.e. particularly a desired pressure level and pressure level distribution, respectively, a desired temperature level and temperature level distribution, respectively, etc., not only in the radial direction of the pressure pipe 2 but also in the axial direction of the pressure pipe 2. In other words, not only cross-sectional areas but also the entire particle processing volume of the pressure pipe 2 can be brought faster, easier, and thus, more efficiently to desired processing conditions and kept at the same, respectively.

Another advantage of the geometric configuration of the pressure pipe 2 is that the pressure-induced mechanical loads, i.e. typically circumferential tension loads, on the pressure pipe 2 are relatively low which enables that the pressure pipe 2 can have a relative low wall thickness. Particularly, the wall thickness of the pressure pipe 2 can be 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, 4.0 mm, 5.0 mm, 6.0 mm, 7.0 mm, 8.0 mm, 9.0 mm, 10.0 mm. The aforementioned wall thickness values can also be threshold values of wall thickness intervals.

As such, the pressure pipe 2 can generally be built from less mechanically stable materials, particularly standard metals, such as aluminum or standard steel, for instance relative to autoclaves of conventional autoclave-based pressurization systems which require high-strength metal grades. Further, the apparatus 1 could even be provided with standard pipes as pressure pipes 2 which can significantly reduce production costs of the apparatus 1 relative to autoclaves of conventional autoclave-based pressurization systems.

Another advantage of the geometric configuration of the pressure pipe 2 is that its footprint is significantly smaller relative to autoclaves of conventional autoclave-based pressurization systems which not only eases installation works, service works, repair works, etc., but also facilitates installing the pressure pipe 2 in environments in which only less installation space is available. Also, a given installation space can be provided with a plurality of pressure pipes 2 in highly efficient manner.

As is apparatus from FIG. 1, the apparatus 1 can further comprise a polymer particle supply device 3 configured to supply a supply stream of polymer particles, particularly a pressurized supply stream of polymer particles, into the particle processing volume 2.1 of the pressure pipe 2. The polymer particle supply device 3 can be arranged or built upstream of the pressure pipe 2 and can be connected to the pressure pipe 2 via one or more connection elements, such as connection pipes, connection tubes, etc.

The supply stream of polymer particles can be a pneumatic polymer particle conveying stream. A respective pneumatic polymer particle conveying stream can comprise a, particularly pressurized, conveying medium and the polymer particles to be supplied into the particle processing volume 2.1 of the pressure pipe 2. The conveying medium may be provided from a conveying medium supply 3.1. The conveying medium supply can, be a gas supply or gas reservoir, respectively. The conveying medium supply 3.1 can be provided through the infrastructure of a superordinate facility, such as a manufacturing facility, in which gases suitable for being used as a respective conveying medium are existent, for instance.

The conveying medium can be a conveying gas. The conveying gas can be air, for instance. The conveying medium may be pressurized and/or tempered. The conveying medium may comprise a pressure in the range of 1.5 bar to 10 bar, for instance.

FIG. 1 also shows that the polymer particle supply device 3 can comprise a polymer particle supply or reservoir 3.2 and a nozzle arrangement 3.3 comprising one or more nozzles, particularly Venturi nozzles. The nozzle arrangement 3.3 is configured to generate a stream of polymer particles of desired properties, i.e. particularly of desired pressure, desired streaming profile, desired streaming velocity, etc.

FIG. 1 also shows that the polymer particle supply device 3 is connectable or connected to a polymer particle inlet opening 2.2.1 of a polymer particle inlet section 2.2 of the pressure pipe 2. The pressure pipe 2 thus, comprises a polymer particle inlet section 2.2 comprising one or more polymer particle inlet openings 2.2.1 through which polymer particles which are to be pressurized via the apparatus 1 can enter the particle processing volume 2.1. The one or more polymer particle inlet openings 2.2.1 are typically provided with a first free end, particularly an upper free end, of the pressure pipe 2 (e.g. when being arranged with its length axis A₁ parallel to a vertical axis). The one or more polymer particle inlet openings 2.2.1 can be provided with the axial face side of the respective first free end of the pressure pipe 2.

FIG. 1 also shows that the apparatus 1 can further comprise a tempering device 7 configured to temper, particularly heat, the polymer particles to be supplied into the particle processing volume 2.1 and/or the conveying medium and/or the conveying stream of polymer particles to be supplied into the particle processing volume 2.1. The tempering device 7 can also be configured to dry the polymer particles and/or the conveying medium and/or the conveying stream of polymer particles, respectively. The tempering device 7 can be arranged or built upstream of the pressure pipe 2. Particularly, the tempering device 7 can be provided with respective connection elements, such as connection pipes, connection tubes, etc., through which the polymer particle supply device 3 is connected to the pressure pipe 2. The tempering device 7 can comprise one or more tempering elements 7.1, such as electrical heating elements, for instance whose operation can be controlled via a hardware- and/or software-embodied control unit of the tempering device 7.

A polymer particle inlet control device 4 can be assigned to the polymer particle inlet section 2.2, particularly the one or more polymer particle inlet openings 2.2.1. The polymer particle inlet control device 4 is configured to control the amount of polymer particles streaming into the particle processing volume 2.1. The polymer particle inlet control device 4 may be built or comprise at least one polymer particle inlet control valve device 4.1 which can comprise one or more valve elements being transferrable in at least one open state in which polymer particles can pass the polymer particle inlet control valve device 4.1 and can be conveyed into the particle processing volume 2.1 through the one or more polymer particle inlet openings 2.2.1, and in at least one closed state in which polymer particles cannot pass the polymer particle inlet control valve device 4.1 and cannot be conveyed into the particle processing volume 2.1 through the one or more polymer particle inlet openings 2.2.1.

The polymer particle inlet control device 4 can be configured to enable a quasi-continuous or discontinuous/batch-wise operation such that polymer particles can stream into the particle processing volume 2.1 in quasi-continuous or discontinuous/batch-wise manner.

The polymer particle inlet control device 4 can comprise a hardware-and/or software-embodied control unit configured to control operation of the polymer particle inlet control device 4. The control unit can communicate with other control units of the apparatus 1 and specifically with a central control unit 5 of the apparatus 1 which is configured to control operation of the apparatus 1. Particularly, the central control unit 5 of the apparatus 1 is configured to implement one or more operating modes of the apparatus 1 examples of which will be mentioned further below.

As is apparent from FIG. 1, the pressure pipe 2 also comprises a polymer particle outlet section 2.3 comprising one or more polymer particle outlet openings 2.3.1 through which pressurized polymer particles can exit the particle processing volume 2.1. The one or more polymer particle outlet openings 2.3.1 are typically provided with a second free end, particularly a lower free end, of the pressure pipe 2 (e.g. when being arranged with its length axis parallel to a vertical axis). The one or more polymer particle outlet openings 2.3.1 can be provided with the axial face side of the respective second free end of the pressure pipe 2.

A polymer particle outlet control device 6 can be assigned to the polymer particle outlet section 2.3, particularly the one or more polymer particle outlet openings 2.3.1. The polymer particle outlet control device 6 is configured to control the amount of pressurized polymer particles streaming out of the particle processing volume 2.1 after pressurization. The polymer particle outlet control device 6 may be built or comprise at least one polymer particle outlet control valve device 6.1 which can comprise one or more valve elements being transferrable in at least one open state in which pressurized polymer particles can pass the polymer particle outlet control valve device 6.1 and can be conveyed out of the particle processing volume 2.1 through the one or more polymer particle outlet openings 2.3.1, and in at least one closed state in which pressurized polymer particles cannot pass the polymer particle outlet control valve device 6.1 and cannot be conveyed out of the particle processing volume 2.1 through the one or more polymer particle outlet openings 2.3.1.

The polymer particle outlet control device 6 can be configured to enable a quasi-continuous or discontinuous/batch-wise operation such that polymer particles can stream out of the particle processing volume 2.1 in quasi-continuous or discontinuous/batch-wise manner.

The polymer particle outlet control device 6 can comprise a hardware-and/or software-embodied control unit configured to control operation of the polymer particle outlet control device 6. The control unit can communicate with other control units of the apparatus 1 and specifically with the central control unit 5 of the apparatus 1.

FIG. 1 also shows that the pressure pipe 2 can comprise a double-walled section provided at or adjacent to the polymer particle inlet section 2.2. The double-walled section can be built through an outer wall structure, which can be the outer wall of the pressure pipe 2, delimiting a first inner volume 2.4 and an inner wall structure arranged or built inside the first inner volume 2.4 delimiting a second inner volume 2.5 of the double-walled section of the pressure pipe 2. The first inner volume 2.4 delimited by the outer wall structure can be or delimit a ring volume. The second inner volume 2.5 delimited by the inner wall structure can be or delimit a cylindrical volume. The first inner volume 2.4 and the second inner volume 2.5 communicate with each other through one or more openings 2.6, e.g. bores, slits, etc., provided with the inner wall structure and being sized and shaped with respect to the size and shape of the polymer particles to be processed within the particle processing volume 2.1 such that the polymer particles cannot penetrate from the second inner volume 2.5 into the first inner volume 2.4 due to their size and/or shape. The one or more openings 2.6 can provide the inner wall structure with a filter-, grid- or sieve-like configuration and functionality, respectively.

The apparatus 1 can further comprise a pressure supply device 9 configured to supply a pressurized gas into the particle processing volume 2.1. The pressure supply device 9 can be connected to a gas inlet section 2.7 of the pressure pipe 2. The gas inlet section 2.7 of the pressure pipe 2 can comprise one or more gas inlet openings 2.7.1. The pressure supply device 9 can be connected to the pressure pipe 2 via one or more connection elements, such as connection pipes, connection tubes, etc. The pressurized gas can be air, which is typically applied for (pre-)expanded polymer particles, or carbon dioxide, which is typically, applied for compact polymer particles, for instance. The pressurized gas can also be a mixture of at least two gases in any case. The pressurized gas may be provided from at least one pressurized gas supplies which can be or comprise a gas supply 9.1 or gas reservoir 9.2, respectively. The pressurized gas supply 9.1 or the gas reservoir 9.2 can be provided through the infrastructure of a superordinate facility, such as a manufacturing facility, in which pressurized gases suitable for being used as a respective pressurized gas are existent.

The pressurized gas supplyable or supplied by the pressure supply device 9 can have an absolute pressure above 1 bar, which is ambient pressure. Particularly, the pressurized gas can have an absolute pressure of 2 bar, 3 bar, 4 bar, 5 bar, 6 bar, 7 bar, 8 bar, 9 bar, 10 bar, 11 bar, 12 bar, 13 bar, 14 bar, 15 bar, 16 bar, 17 bar, 18 bar, 19 bar, 20 bar, 21 bar, 22 bar, 23 bar, 24 bar, 25 bar, 26 bar, 27 bar, 28 bar, 29 bar, 30 bar, 31 bar, 32 bar, 33 bar, 34 bar, 35 bar, 36 bar, 37 bar, 38 bar, 39 bar, 40 bar, 41 bar, 42 bar, 43 bar, 44 bar, 45 bar, 46 bar, 47 bar, 48 bar, 49 bar, 50 bar. The aforementioned pressure values can also be threshold values of pressure intervals.

As such, the pressure inside the particle processing volume 2.1, at least during operation of the pressure pipe 2 in a pressurizing mode, can also be above 1 bar. The aforementioned pressure levels of the pressurized gas supplyable or supplied by the pressure supply device 9 can correspond to the pressure levels within the particle processing volume 2.1 of the pressure pipe 2 at least during operation of the apparatus 1 in a pressurizing mode.

A gas inlet control device 10 can be assigned to the gas inlet section 2.7, particularly the one or more gas inlet openings 2.7.1 of the gas inlet section 2.7. The gas inlet control device 10 is configured to control the amount of pressurized gas streaming into the particle processing volume 2.1. The gas inlet control device 0 may be built or comprise at least one gas inlet control valve device 10.1 which can comprise one or more valve elements being transferrable in at least one open state in which pressurized gas can pass the gas inlet control valve device 10.1 and can stream into the particle processing 2.1 volume through the one or more gas inlet openings 2.7.1, and in at least one closed state in which pressurized gas cannot pass the gas inlet control valve device 10.1 and cannot stream into the particle processing volume 2.1 through the one or more gas inlet openings 2.7.1.

The gas inlet control device 10 can be configured to enable a continuous, quasi-continuous or discontinuous operation such that pressurized gas can stream into the particle processing volume 2.1 in continuous, quasi-continuous or discontinuous manner.

The gas inlet control device 10 can comprise a hardware-and/or software-embodied control unit configured to control operation of the gas inlet control device 10. The control unit can communicate with other control units of the apparatus 1 and specifically with the central control unit 5 of the apparatus 1.

The gas inlet section 2.7 of the pressure pipe 2 can also be provided with the double-walled section of the pressure pipe 2. Particularly, the gas inlet section 2.7 can be provided adjacent to the polymer particle inlet section 2.2 which is typically provided at the first free end of the pressure pipe 2.

The gas inlet section 2.7 and the gas outlet section 2.8 of the pressure pipe 2 can co-act to control or regulate pressurization of the pressure pipe 2 and the particle processing volume 2.1, respectively. A respective control or regulation of pressurization of the pressure pipe 2 and the particle processing volume 2.1, respectively can be effected by an alternating operation of the gas inlet control device 10 and the gas outlet control device 12, respectively. Particularly, a respective control or regulation of pressurization of pressure pipe 2 and the particle processing volume 2.1 can comprise a first step which comprises opening the gas inlet control device 10 for a specific time such that pressurized gas can stream into the particle processing volume 2.1 thereby, increasing the pressure inside the particle processing volume 2.1 about a certain amount, e.g. to reach a first (upper) threshold pressure, while the gas outlet control device 12 is closed, and a second step which comprises closing the gas inlet control device 10 such that no pressurized gas can stream into the particle processing volume 2.1 and opening the gas outlet control device 12 for a specific time such that pressurized gas can stream out of the particle processing volume 2.1 thereby, decreasing the pressure inside the particle processing volume 2.1 about a certain amount, e.g. to reach a second (lower) threshold pressure. By operating the gas inlet control device 10 and the gas outlet control device 12 to alternatingly implement the two steps, a reliable control and regulation of the pressure inside the pressure pipe 2 and the particle processing volume 2.1, respectively is feasible. A respective alternating operation of the gas inlet control device 10 and the gas outlet control device 12 can be effected through the central control unit 5, for instance.

The apparatus 1 can further comprise a tempering device 11 configured to temper, particularly heat, the pressurized gas to be supplied to the pressure pipe 2. The tempering device 11 can also be configured to dry the pressurized gas. The tempering device 11 can be provided with respective connection elements, such as connection pipes, connection tubes, etc., through which the pressure supply device is connected to the pressure pipe 2. The tempering device 11 can comprise one or more tempering elements 11.1, such as electrical heating elements, for instance whose operation can be controlled via a hardware-and/or software-embodied control unit of the tempering device 11.

As is apparent from FIG. 1, the pressure pipe 2 can further comprise a gas outlet section 2.8. The gas outlet section 2.8 can comprise one or more gas outlet openings 2.8.1 through which gas, such as a, particularly pressurized, gaseous conveying medium of a supply stream of polymer particles, can exit the particle processing volume 2.1, e.g. in a filling mode of the apparatus 1 in which the particle processing volume 2.1 is filled with polymer particles which are to be pressurized.

A gas outlet control device 12 can be assigned to the gas outlet section 2.8, particularly the one or more gas outlet openings 2.8.1 of the gas outlet section 2.8. The gas outlet control device 12 is configured to control the amount of gas streaming out of the pressure pipe 2, e.g. in a respective filling mode of the apparatus 1. The gas outlet control device 12 may be built or comprise at least one gas outlet control valve device 12.1 which can comprise one or more valve elements being transferrable in at least one open state in which gas can pass the gas outlet control valve device 12.1 and can stream out of the pressure pipe 2 through the one or more gas outlet openings 2.8.1, and in at least one closed state in which gas cannot pass the gas outlet control valve device 12.1 and cannot stream out of the pressure pipe 2 through the one or more gas outlet openings 2.8.1.

The gas outlet control device 12 can be configured to enable a continuous, quasi-continuous or discontinuous operation such that gas can stream out of the pressure pipe 2 in continuous, quasi-continuous or discontinuous manner.

The gas outlet control device 12 can comprise a hardware-and/or software-embodied control unit configured to control operation of the gas outlet control device 12. The control unit can communicate with other control units of the apparatus 1 and specifically with the central control unit 5 of the apparatus 1.

The gas outlet section 2.8 of the pressure pipe 2 can also be provided with the double-walled section of the pressure pipe 2. Particularly, the gas outlet section 2.8 can be provided adjacent to the polymer particle inlet section 2.2. More particularly, the gas outlet section 2.8 can be provided in between the polymer particle inlet section 2.2 and the gas inlet section 2.7. As indicated above, the polymer particle inlet section 2.2 is typically provided at the first free end of the pressure pipe 2. Providing the gas outlet section 2.8 with the double-walled section of the pressure pipe 2 assures that only gas and no polymer particles can exit the pressure pipe 2 through the gas outlet section 2.8 and the respective gas outlet openings 2.8.1, respectively.

The apparatus 1 can further comprise a dampening device 13, particularly an acoustic dampening device, connectable or connected to the gas outlet section 2.8 and configured to dampen, i.e. particularly decompress, a pressurized gas stream exiting the pressure pipe 2 through the gas outlet section 2.8. The dampening device 13 can comprise a dampening structure comprising one or more dampening elements, such as dampening walls, enabling dampening noise originating from gas streaming out of the pressure pipe 2 through the one or more gas outlet openings 2.8.1 of the gas outlet section 2.8. As is apparent from FIG. 1, the dampening device 13 can be arranged or built upstream of the gas outlet control device 12.

The apparatus 1 further comprises a heating device 14 configured to heat the particle processing volume 2.1 of the pressure pipe 2. Heating the particle processing volume 2.1 and thus, the polymer particles filled therein can significantly improve efficiency of the pressurizing process of the polymer particles. As explained above, the pressure pipe 2 can, due to its special geometric configuration, enable a faster achievement of desired processing conditions, such as a desired temperature level and temperature level distribution, respectively, etc., not only in the radial direction of the pressure pipe 2 but also in the axial direction of the pressure pipe 2. In other words, not only cross-sectional areas but also the entire particle processing volume 2.1 of the pressure pipe 2 can be brought faster, easier, and thus, more efficiently to a desired temperature level and kept at the same, respectively. The heating device 14 can particularly, be configured to heat the particle processing volume to a temperature in the range between 10-100° C., particularly in the range between 30-80° C.; more particularly in the range between 50-60° C. Typically, the temperature will be selected under consideration of the properties of the polymer particles to be pressurized, i.e. particularly under consideration of at least one of the softening temperature, the glass transition temperature, the melting temperature.

The heating device 14 can be configured to generate a plurality of temperature zones having same or different temperatures within the particle processing volume 2.1. As such, a highly individualized temperature control of the particle processing volume 2.1 can be implemented. As indicated above, a respective temperature control typically, aims at a constant temperature level and/or temperature distribution throughout the entire particle processing volume 2.1 of the pressure pipe 2 to ensure consistent pressurization of the polymer particles and thus, loading of the polymer particles with gas irrespective of their location within the particle processing volume 2.1.

The heating device 14 can comprise a hardware- and/or software embodied control device to control operation of the heating device 14. The control unit can communicate with other control units of the apparatus 1 and specifically with the central control unit 5 of the apparatus 1.

Hence, the control unit of the heating device 14 can particularly be configured to control operation of the heating device 14 such that a specific temperature or temperature distribution, e.g. a constant temperature or constant temperature distribution, is provided inside the pressure pipe 2, particularly inside the particle processing volume 2.1, particularly during pressurization of polymer particles inside the particle processing volume 2.1. Particularly, the control unit of the heating device 14 can be configured to control operation of the heating device 14 such that specific temperature profiles within the particle processing volume 2.1 are created, adjusted, or maintained. Respective temperature profiles can e.g. compensate for possible convection and/or diffusion effects, promote the ability to solve gas within the polymer particles, promote the ability to diffuse gas into the polymer particles. Respective temperatures profiles can be material-and/or process-specific such that each material and/or process can be processed/implemented its own temperature profile.

The heating device 14 can comprise one or more heating elements 14.1. The one or more heating elements 14.1 can be arranged at different locations of the pressure pipe 2, particularly the outer surface of the pressure pipe 2, and/or one can extend in different directions along the pressure pipe 2, particularly the outer surface of the pressure pipe 2. Each heating element 14.1 can be assigned to a specific temperature zone of the pressure pipe 2. Each heating element 14.1 can comprise an electric heating element and/or a heating channel element through which a heating medium may stream, for instance.

FIG. 1 further shows that the pressure pipe 2 can be at least partially, particularly completely, surrounded by a thermal insulation element 15. The thermal insulation element 15 enables an efficient temperature control within the particle processing volume 2.1 because it avoids or reduces undesired temperature losses which also results in an improved energy consumption of the apparatus 1. The thermal insulation element 15 can be made from a thermally insulating material, such as e.g. glass fibers, mineral fibers, plastics foams, etc., and/or form a thermally insulating material structure, e.g. a glass textile structure, mineral fiber textile structure, plastics foams structure, etc.

The apparatus 1 can comprise one more sensor elements 16 configured to sense chemical and/or physical quantities of or within the pressure pipe 2 and/or of or within one or more of the aforementioned devices of the apparatus 1. Respective sensor elements 16 can thus, be provided with the pressure pipe 2, particularly with the particle processing volume 2.1, and/or with at least one of the polymer particle supply device 3, the pressure supply device 9, the polymer particle inlet control device 4, the polymer particle outlet control device 6, the gas inlet control device 10, the gas outlet control device 12, and/or respective connection elements, such as connection pipes, connection tubes, etc.

Particularly, the apparatus 1 can comprise one more sensor elements 16 configured to sense chemical and/or physical quantities within the particle processing volume 2.1 during one or more operating modes of the apparatus 1. Respective sensor information can be used to control operation of the apparatus 1, e.g. to implement a sensor-information-based control loop, during one or more operating modes of the apparatus 1.

As a concrete example, the apparatus 1 can comprise one or more pressure sensors and/or temperature sensors configured to detect the pressure level and/or temperature level in the particle processing volume 2.1. Respective pressure values and/or temperature values can, particularly together with other one or more other sensor values, be used by respective control units for controlling operation of the apparatus 1.

FIG. 1 also shows that the pressure pipe 2.1 can be vertically oriented arranged. In a vertically oriented arrangement, the length axis A₁ of the pressure pipe 2 extends (essentially) parallel to a vertical axis which enables the use of gravity forces for filling and/or de-filling of the particle processing volume 2.1 of the pressure pipe 2.

However, even if not shown in FIG. 1 an inclined oriented arrangement of the pressure pipe 2 is also conceivable. In an inclined oriented arrangement, the length axis A₁ of the pressure pipe 2 extends inclined to a vertical axis which typically still enables the use of gravity forces for filling and/or de-filling of the particle processing volume of the pressure pipe 2. As such, the inclination angle of the length axis A₁ of the pressure pipe 2 relative to a vertical axis can be in the range of 1 to 75°, more particularly in the range of 1 to 65°, more particularly in the range of 1 to 55°, more particularly in the range of 1 to 45°, more particularly in the range of 1 to 35°, more particularly in the range of 1 to 25°, more particularly in the range of 1 to 15°, more particularly in the range of 1 to 5°, relative to a vertical axis.

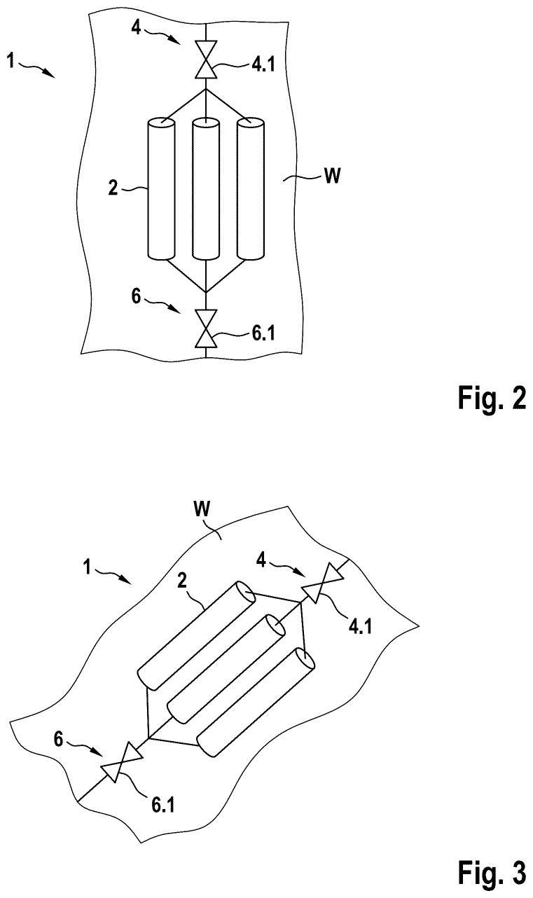

In a configuration of the apparatus 1 with multiple pressure pipes 2 as is shown in the exemplary embodiment of FIG. 2 (vertical arrangement of pressure pipes 2) and FIG. 3 (inclined arrangement of the pressure pipes 2), the inclined parallel arrangement of pressure pipes 2 can result in an optimized use of an available installation space relative to the total available particle processing volume.

As such, in a configuration of the apparatus 1 with multiple pressure pipes 2, two, more than two or all of the multiple pressure pipes 2 can be arranged in parallel.

It is also clear from the above that each pressure pipe 2 typically, comprises one or more mounting interfaces for mounting the pressure pipe 2 e.g. to a wall W, particularly a vertically extending wall W (as schematically indicated in FIGS. 2, 3), or any other mounting structure, such as a rack, shelve, etc., of a given infrastructure. Mounting the pressure pipe 2 to a wall or any other mounting structure can enable the vertical or inclined arrangement specified further above. Respective mounting interfaces provided with a respective pressure pipe 2 can, e.g., be or comprise mechanical interfaces which enable a detachable attachment of the pressure pipe 2.

It has been mentioned above that the apparatus 1 is operable and can thus, be operated in one or more operating modes which are typically coordinated and/or implemented by the central control unit 5. Non-limiting examples of respective operating modes of the apparatus 1 are set forth in the following:

The apparatus 1 can be operable in a filling mode in which the particle processing volume 2.1 is fillable or filled with polymer particles which are to be pressurized to generate a specific expansion behavior or expansion capability, respectively. The implementation of the filing mode can be effected through the central control unit 5 of the apparatus 1. The central control unit 5 can communicate with one or more devices of the apparatus 1 required for enabling the filling mode.

In the filling mode, which can comprise continuous, quasi-continuous or discontinuous filling of the particle processing volume 2.1 with polymer particles which are to be pressurized, the following processes can be implemented in series or in parallel:

The polymer particle supply device 3 supplies polymer particles into the particle processing volume 2.1 so as to fill the particle processing volume 2.1 with polymer particles which are to be pressurized. Typically, the particle processing volume 2.1 is completely filled with polymer particles which are to be pressurized. Thus, the polymer particle inlet control device 4 enables filling the particle processing volume 2.1 with polymer particles. As such, the one or more polymer particle inlet control valve devices 4.1 are in an open state. Particularly, respective one or more valve elements are transferred in their respective at least one open state in which polymer particles which are to be pressurized can pass the one or more control valve devices 4.1 and can be conveyed into the particle processing volume 2.1.

The gas outlet control device 12 (if present) enables removing gas through the gas outlet section 2.8 in the filling mode. As such, the one more gas outlet control valve devices 12.1 are in an open state in the filling mode. Particularly, respective one or more valve elements are transferred in their respective at least one open state in which gas can pass the one or more gas outlet control valve devices 12.1 and can stream out of the particle processing volume 2.1 through the one or more gas outlet openings 2.8.1. As such, the filling of the particle processing volume 2.1 with polymer particles which are to be pressurized can be effected or at least supported by gravity forces. Particularly, the particle processing volume 2.1 can simply be filled by having the polymer particles fall into it.

Also the polymer particle outlet control device 6 enables filling the particle processing volume with polymer particles which are to be pressurized. As such, the one or more polymer particle outlet control valve devices 6.1 can be in a closed state in the filling mode. Particularly, respective one or more valve elements are transferred in their respective at least one closed state in which polymer particles cannot pass the one or more polymer particle outlet control valve devices 6.1 and cannot be conveyed out of the particle processing volume 2.1 through the one or more polymer particle outlet openings 2.3.1.

Another exemplary operating mode of the apparatus 1 is a pressurizing mode in which the particle processing volume 2.1 and the polymer particles filled therein are set under pressure. The pressurizing mode can comprise continuous, quasi-continuous or discontinuous pressurization of the particle processing volume 2.1 and the polymer particles filled therein. The implementation of the pressurizing mode can be effected through the central control unit 5 of the apparatus 1. The central control unit 5 can communicate with one or more devices of the apparatus 1 required for enabling the pressurizing mode. In the pressurizing mode the following processes can be implemented in series or in parallel:

The polymer particle inlet control device 4 enables pressurizing the particle processing volume and the polymer particles filled therein. As such, the one or more polymer particle inlet control valve devices 4.1 are typically in a closed state. Particularly, respective one or more valve elements are transferred in their respective at least one closed state in which polymer particles cannot pass the one or more polymer particle inlet control valve devices 4.1 and cannot be conveyed out of the particle processing volume 2.1 through the one or more polymer particle inlet openings 2.2.1.

The one or more polymer particle inlet control valve devices 4.1 can be transferred in the open state for re-pressurization of the particle processing volume 2.1 at least at one or more specific times during the pressurizing mode. Particularly, respective one or more valve elements can be transferred in their respective at least one open state such that pressurized gas, e.g. supplied from a pressurized gas reservoir 17 of the apparatus 1, can pass the one or more polymer particle inlet control valve devices 4.1 and can be supplied into the particle processing volume 2.1. As such, the one or more polymer particle inlet control devices 4.1 can also be used for supplying a pressurized gas into the particle processing volume 2.1 at one or more specific times during the pressurizing mode to implement or maintain a desired, particularly material-specific, pressure level inside the particle processing volume 2.1 during pressurization of the polymer particles. Respective times can comprise cyclic or regular time intervals or anti-cyclic or irregular time intervals.

Optionally, the gas outlet control device 12 does not enable removing gas through the gas outlet section 2.8 of the pressure pipe 2 in the pressurizing mode. As such, the one or more gas outlet control valve devices 12.1 are in a closed state. Particularly, respective one or more valve elements are transferred in their respective at least one closed state in which gas cannot pass the one or more gas outlet control valve devices 12.1 and cannot stream out of the particle processing volume 2.1 through the one or more gas outlet openings 2.8.1.

Also, the polymer particle outlet control device 6 enables pressurizing the particle processing volume 2.1 and the polymer particles filled therein in the pressurizing mode. As such, the one or more polymer particle outlet control valve devices 6.1 are in a closed state in the pressurizing mode. Particularly, respective one or more valve elements are transferred in their respective at least one closed state in which polymer particles cannot pass the one or more polymer particle outlet control valve devices 6.1 and cannot be conveyed out of the particle processing volume 2.1 through the one or more polymer particle outlet openings 2.3.1.

The pressure supply device 9 enables pressurizing the particle processing volume 2.1 and the polymer particles filled therein in the pressurizing mode. As such, the one or more gas inlet control devices 10.1 are at least in an initial state of the pressurizing mode in an open state. Particularly, respective one or more valve elements are transferred in their respective at least one open state in which pressurized gas can pass the one or more gas inlet control devices 10.1 and can be supplied into the particle processing volume 2.1 through the gas inlet openings 2.7.1.

The constructive and/or functional configuration of the pressure pipe 2 can enable that an overfilling of the polymer particle processing volume 2.1 is not possible because an inverse stream of polymer particles will be automatically generated inside the pressure pipe 2 above a certain threshold filling level. A respective inverse stream will effect that the conveying medium, typically including polymer particles, will change its streaming direction inside the polymer particle processing volume 2.1 and effectively stream in inversed direction towards the polymer particle inlet section 2.2 because the conveying medium cannot exit the pressure pipe via the gas outlet section 2.8 due to the (high) filling level which obstructs the conveying medium from exiting the pressure pipe 2 via the gas outlet section 2.8. As such, a self-regulatory filling mode is feasible which does typically not require separate fill-level sensors which oftentimes provide only non-satisfying fill-level information.

Another exemplary operating mode of the apparatus 1 is a de-filling mode in which the pressurized polymer particles are de-filled from the particle processing volume 2.1. The de-filling mode can comprise continuous, quasi-continuous or discontinuous de-filling of the particle processing volume 2.1. The implementation of the de-filling mode can be effected through the central control unit 5 of the apparatus 1. The central control unit 5 can communicate with one or more devices of the apparatus 1 required for enabling the de-filling mode. In the de-filling mode one or more of the following processes can be implemented in series or in parallel:

The polymer particle supply device 3 does not supply polymer particles into the particle processing volume 2.1 in the de-filling mode. Thus, the polymer particle inlet control device 4 enables de-filling the particle processing volume 2.1 through the one or more polymer particle outlet openings 2.3.1. As such, the one or more polymer particle inlet control valve devices 4.1 are typically in a closed state. Particularly, respective one or more valve elements are typically transferred in their respective at least one closed state in which polymer particles cannot pass the one or more polymer particle inlet control valve devices 4.1 and cannot be conveyed into the particle processing volume 2.1 through the one or more polymer particle inlet openings 2.2.1.

Also the gas outlet control device 12 (if present) enables de-filling the particle processing volume 2.1 through the one or more polymer particle outlet openings 2.3.1 in the de-filling mode. As such, the one more gas outlet control valve devices 12.1 are typically in a closed state. Particularly, respective one or more valve elements are transferred in their respective at least one closed state in which gas cannot pass the one or more gas outlet control valve devices 12.1 and cannot stream out of the particle processing volume 2.1 through the one or more gas outlet openings 2.8.1.

The polymer particle outlet control device 6 enables de-filling the particle processing volume 2.1 to remove polymer particles through the one or more polymer particle outlet openings 2.1 in the de-filling mode. As such, the one or more polymer particle outlet control devices are in an open state. Particularly, respective one or more valve elements are transferred in their respective at least one open state in which pressurized polymer particles can pass the one or more polymer particle outlet control devices 6.1 and can be conveyed out of the particle processing volume 2.1 through the one or more polymer particle outlet openings 2.3.1.

As such, also de-filling of the particle processing volume 2.1 can be effected or at least supported through gravity forces. Particularly, the particle processing volume 2.1 can simply be de-filled by having the pressurized polymer particles fall through the one or more polymer particle outlet openings 2.3.1.

The apparatus 1 can also be configured to implement a cleaning mode in which cleaning of the particle processing volume 2.1 of the pressure pipe 2 is possible. Cleaning may particularly comprise removing polymer particle removing residues from the particle processing volume which can e.g. be required when polymer particles having different chemical and/or physical properties relative to previously processed polymer particles are to be pressurized. The implementation of the cleaning mode can be effected through the central control unit 5 of the apparatus 1. The central control unit 5 can communicate with one or more devices of the apparatus 1 required for enabling the cleaning mode. In the cleaning mode, which can comprise continuous, quasi-continuous or discontinuous cleaning of the particle processing volume, one or more of the following processes can be implemented in series or in parallel:

In the cleaning mode, the polymer particle supply device 3 does not supply polymer particles into the particle processing volume 2.1. Yet, the polymer particle inlet control device 4 enables supplying a continuous, quasi-continuous or discontinuous stream of cleaning fluid, e.g. a pressurized cleaning gas, such as pressurized air, into the particle processing volume 2.1 of the through the one or more polymer particle inlet openings 2.2.1. As such, the one or more polymer particle inlet control valve devices 4.1 are typically in an open state. Particularly, respective one or more valve elements are typically transferred in their respective at least one open state in which a stream of cleaning fluid can pass the one or more polymer particle inlet control valve devices 4.1 and can stream into the particle processing volume 2.1 through the one or more polymer particle inlet openings 2.2.1.

Also the gas outlet control device 12 can enable cleaning the particle processing volume 2.1 with a respective stream of a cleaning fluid in the cleaning mode. As such, the one more gas outlet control devices 12.1 are typically in a closed state. Particularly, respective one or more valve elements are transferred in their respective at least one closed state in which gas cannot pass the one or more gas outlet control valve devices 12.1 and cannot stream out of the particle processing volume 2.1 through the one or more gas outlet openings 2.8.1.

Also the polymer particle outlet control device 6 enables cleaning the particle processing volume 2.1 with a respective stream of a cleaning fluid. As such, the one or more polymer particle outlet control valve devices 6.1 are in an open state in the cleaning mode. Particularly, respective one or more valve elements are transferred in their respective at least one open state in which the stream of cleaning fluid can pass the one or more polymer particle outlet control valve devices 6.1 and can stream out of the particle processing volume 2.1 through the one or more polymer particle outlet openings 2.3.1.

As such, cleaning of the particle processing volume 2.1 can be effected by one or more streams of cleaning gas streaming through the particle processing volume 2.1. The one or more streams of cleaning gas typically, enter the particle processing volume 2.1 via the more polymer particle inlet openings 2.2.1 and exit the particle processing volume 2.1 via the one or more polymer particle outlet openings 2.3.1. As such, the one or more streams of cleaning gas typically stream through the entire particle processing volume 2.1, thereby removing undesired residues, such as polymer particle residues, resulting in an efficient and thorough cleaning of the particle processing volume 2.1. Further, a chemical and/or physical conditioning of the particle processing volume 2.1 can be effected, particularly when the cleaning gas has specific chemical and/or physical properties, such as a specific chemical composition, a specific temperature, etc.

A respective stream of cleaning gas can be provided as one or more distinct pressure boosts, pressure impulses, or pressure waves, respectively. Respective pressure boosts, pressure impulses, or pressure waves can have a pressure between 5 and 25 bar, particularly between 5 and 15 bar, for instance.

For enabling a respective cleaning mode, the apparatus 1 can comprise the aforementioned cleaning device 18 configured to generate or provide at least one stream of cleaning fluid, such as a pressurized cleaning gas. The cleaning device 18 can comprise pressurized gas reservoir 17, can be arranged or built upstream of the pressure pipe 2 and can be connected to the at least one pressure pipe via one or more connection elements, such as connection pipes, connection tubes, etc. As is apparent from FIG. 1, the cleaning device 18 can particularly be arranged or provided upstream of the one or more polymer particle inlet control devices 4.1.

FIG. 4-6 each shows an exemplary scheme of implementing operating modes of the or an apparatus 1 according to an exemplary embodiment.

FIG. 4-6 show that one, more, or all of the above-specified exemplary operating modes of the apparatus 1 can also be implemented when the apparatus 1 comprises multiple pressure pipes 2, particularly in a parallel arrangement. The fact the embodiments of FIG. 4-6 relate to an apparatus 1 with six pressure pipes 2 and compare the output of the apparatus 1 with a conventional autoclave (see upper half of the Fig.) is only of exemplary nature and not limiting. In the exemplary configuration of the apparatus 1 with multiple pressure pipes 2, the following operation of the apparatus 2 is conceivable and can be effected e.g. via the central control unit 5 of the apparatus 1:

FIG. 4-6 generally show that a first pressure pipe 2 (upper pressure pipe) can be operated in a filling mode indicated by letter “F” in a time interval between a first time t1 and a second time t2. After filling mode is completed, the first pressure pipe 2 can be operated in a pressurizing mode indicated by letter “P” in a time interval between a third time t3 and a fourth time t4. Notably, the third time t3 can be the same as the second time t2 or can be after the second time t2. After pressurizing mode is completed, the first pressure pipe 2 can be operated in a de-filling mode or manufacturing mode indicated by letter “M” in a time interval between a fifth time t5 and a sixth time t6. Notably, the fifth time t5 can be the same as the fourth time t4 or can be after the fourth time t4. The filling, pressurization, and de-filling of the first pressure pipe 2 can be deemed a first operating cycle of the first pressure pipe 2. After a respective first operating cycle is completed, i.e. particularly after completing the de-filling mode at the time t6 and possibly considering an optional idling time of a secondary process indicated by letter “I”, one or more further operating cycles of the first pressure pipe 2 can be conducted in the same or similar manner.

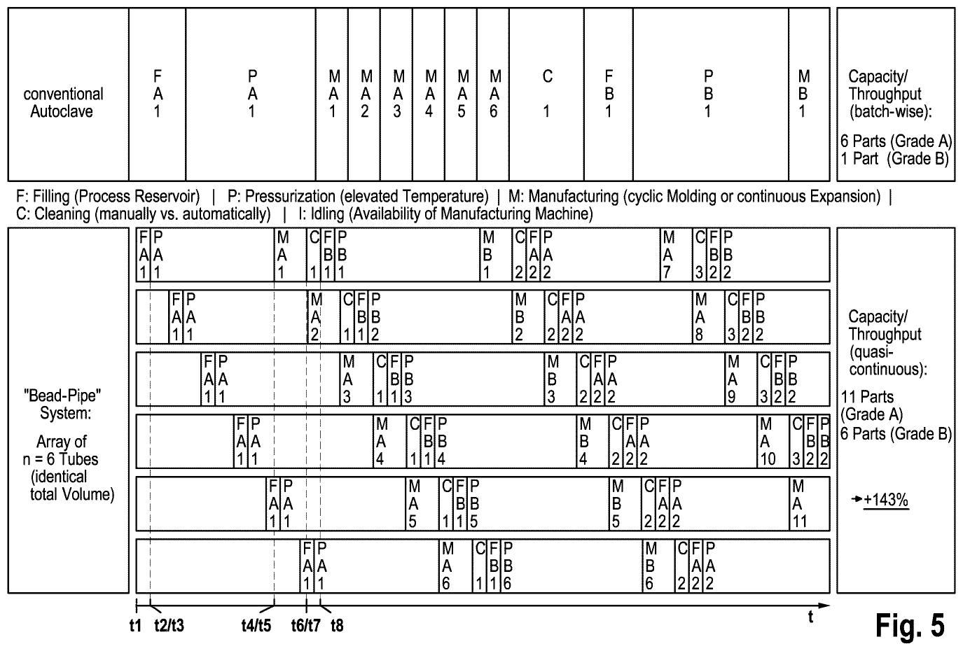

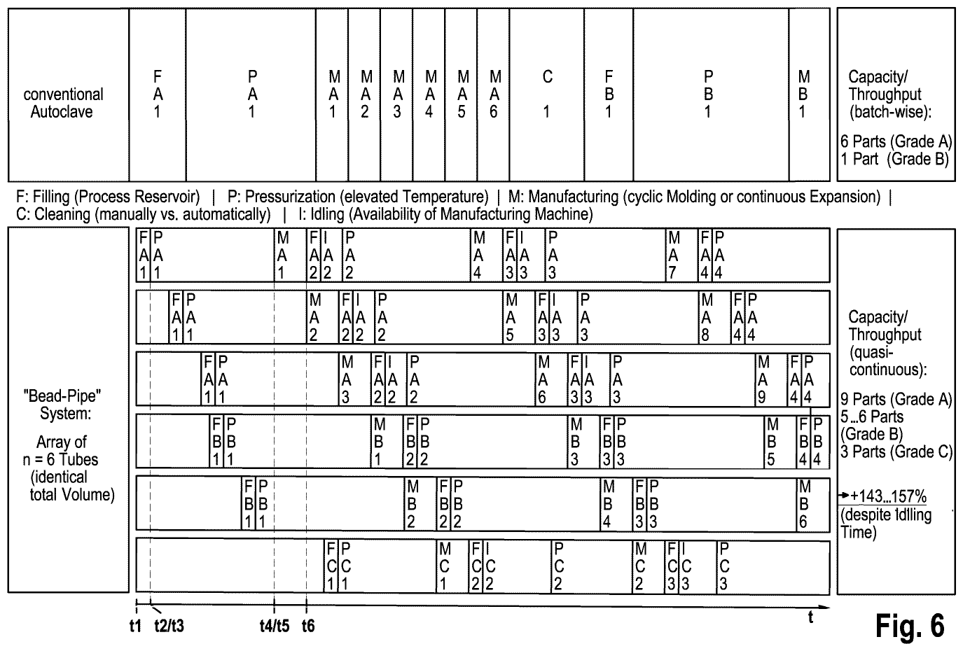

The same applies when the first operating cycle further comprises implementing a cleaning mode after completion of the de-filling mode indicated by letter “F” as is shown in FIG. 5. The implementation of a cleaning mode after completion of the de-filling mode can be required when chemically and/or physically different polymer particles indicated by letter “A” indicating polymer particles of grade/type A, letter “B” indicating polymer particles of grade/type B, and letter “C” indicating polymer particles of grade/type C in FIGS. 5 and 6 are to be processed in the pressure pipes, for instance. In this case, the first pressure pipe 2 would be operated in a cleaning mode in a time interval between a seventh time t7 and an eighth time t8. Notably, the seventh time t7 can be the same as the sixth time t6 or can be after the sixth time t6. Again, after a respective first operating cycle which also includes a respective cleaning mode is completed, i.e. after completing the cleaning mode at the time t8, one or more further operating cycles of the first pressure pipe can be conducted in same or similar manner.

As is apparent from FIG. 4-6 , also the other pressure pipes 2 can be operated in respective operating cycles. The operating cycles of the other pressure pipes can implement the same start times and end times for their respective operating modes as the first pressure pipe and can thus, also have the same duration for their respective operating modes as the first pressure pipe. Thus, the filling mode (and the subsequent modes) of a second pressure pipe can start at the same time as the filling mode (and the subsequent modes) of a first pressure pipe and can have the same duration (which particularly, applies for pressure pipes of the same functional and constructive configuration). This also means that the overall duration of an operating cycle of a second pressure pipe can be the same as the overall duration of an operating cycle of a first pressure pipe, or vice versa.

However, FIG. 4-6 show that it is also conceivable that the operating cycles of the other pressure pipes 2 can be shifted in time which means that an operating cycle of a second pressure pipe 2 starts with a specific time delay after the start of the operating cycle of a first pressure pipe 2. Thus, e.g. the filling mode (and the subsequent modes) of a second pressure pipe can start with a specific time delay relative to the filling mode (and the subsequent modes) of a first pressure pipe 2 such that, given that the respective modes have the same duration (which particularly, applies for pressure pipes of the same functional and constructive configuration), the first operating cycle of the second pressure pipe 2 also ends with the respective time delay relative to the operating cycle of the first pressure pipe 2. This also applies to all other pressure pipes 2 in analogous manner.

Applying this principle of operating multiple pressure pipes 2 with timely shifted operating cycles can result in that the apparatus 1 provides for a quasi-continuous or continuous output of pressurized polymer particles which can result in a significant increase of efficiency compared with conventional autoclave-based pressurizing systems as shown by FIG. 4-6. This particularly, applies when considering the smaller space (footprint) required for installation of respective pressure pipes 2 compared with conventional autoclave-based pressurizing systems. This also applies, when considering the cumbersome cleaning of conventional autoclave-based pressurizing systems which can require hours of cleaning effort.

The apparatus 1 thus, also enables implementing a method for pressurizing polymer particles with gas to generate a specific expansion behavior or expansion capability, respectively of the polymer particles.

The method can comprise the steps of filling the particle processing volume of at least one pressure pipe with polymer particles and pressurizing the polymer particles in the particle processing volume for a specific time so as to obtain pressurized polymer particles having a specific expansion capability.

The method can particularly, comprise implementing one or more of the operating modes of the apparatus 1 as specified above.

The method can thus, be implemented via the central control unit 5 of the apparatus 1 as mentioned above.

1. An apparatus for pressurizing polymer particles with gas to generate a specific expansion capability of the polymer particles, the apparatus comprising at least one pressure pipe comprising a polymer particle processing volume, wherein the at least one pressure pipe comprises a length and an inner diameter, wherein the ratio of the length relative to the inner diameter is 5 or more, and wherein the inner diameter is equal or less 500 mm.

2. The apparatus of claim 1, further comprising a polymer particle supply device configured to supply a supply stream of polymer particles into the particle processing volume of the at least one pressure pipe.

3. The apparatus of claim 1, wherein the at least one polymer particle supply device is connectable or connected to at least one polymer particle inlet opening of a polymer particle inlet section of the at least one pressure pipe, wherein the polymer particle inlet section of the at least one pressure pipe comprises a double-walled section of the at least one pressure pipe.

4. (canceled)

5. The apparatus of claim 1, further comprising a polymer particle inlet control device assigned to the polymer particle inlet section the polymer particle inlet control device configured to control the amount of polymer particles streaming into the particle processing volume.

6. The apparatus of claim 1, wherein the at least one pressure pipe has at least one inlet opening and an polymer particle inlet outlet control device configured to control the amount of polymer particles streaming in of the particle processing volume; and/or the at least one pressure pipe has at least one outlet opening of the at least one pressure pipe, and an polymer particle outlet control device configured to control the amount of polymer particles streaming out of the particle processing volume.

7. (canceled)

8. The apparatus of any claim 1, wherein the wall thickness of the at least one pressure pipe is at least one of: 0.5 mm, 0.6 mm, 0.7 mm, 0.8 mm, 0.9 mm, 1.0 mm, 1.1 mm, 1.2 mm, 1.3 mm, 1.4 mm, 1.5 mm, 1.6 mm, 1.7 mm, 1.8 mm, 1.9 mm, 2.0 mm, 2.1 mm, 2.2 mm, 2.3 mm, 2.4 mm, 2.5 mm, 2.6 mm, 2.7 mm, 2.8 mm, 2.9 mm, 3.0 mm, 4.0 mm, 5.0 mm, 6.0 mm, 7.0 mm, 8.0 mm, 9.0 mm, 10.0 mm.

9. The apparatus of claim 1, wherein the at least one pressure pipe can comprise at least one double-walled section, the polymer particle inlet section of the at least one pressure pipe is provided with the at least one double-walled section of the at least one pressure pipe.

10. The apparatus of claim 1, wherein the at least one double-walled section of the at least one pressure pipe is built through an outer wall structure delimiting a first inner volume of the at least one double-walled section of the at least one pressure pipe, and an inner wall structure arranged or built inside the first inner volume of the at least one pressure pipe and delimiting a second inner volume of the at least one double-walled section of the at least one pressure pipe; wherein the first inner volume and the second inner volume communicate with each other through one or more openings provided with the inner wall structure; wherein the one or more openings being sized and shaped with respect to the size and shape of the polymer particles to be processed within the particle processing volume of the at least one pressure pipe such that the polymer particles cannot penetrate from the second inner volume into the first inner volume.

11. (canceled)

12. The apparatus of claim 10, wherein the at least one double-walled section is configured to separate the polymer particles from a conveying medium such that the conveying medium can exit the at least one pressure pipe via the inner wall structure of the at least one double-walled having one or more openings, the outer wall structure of the at least one double-walled section, and a gas outlet section of the at least one pressure pipe, wherein the polymer particles, after being separated from the conveying medium, can fall into the at least one pressure pipe and particle processing volume, based on gravitational forces.

13. The apparatus of claim 1, further comprising a pressure supply device configured to supply a pressurized gas into the particle processing volume of the at least one pressure pipe, wherein the pressurized gas supplyable or supplied by the pressure supply device can have an absolute pressure above 1 bar or above ambient pressure, respectively.

14. (canceled)

15. The apparatus of claim 1, wherein the at least one pressure pipe comprises at least one gas inlet section, wherein at least one gas inlet control device is assigned to the gas inlet section of the at least one pressure pipe, wherein the gas inlet section of the at least one pressure pipe is provided with the at least one double-walled section of the at least one pressure pipe.

16. (canceled)

17. (canceled)

18. The apparatus of claim 1, wherein the at least one pressure pipe comprises at least one gas outlet section, wherein at least one gas outlet control device is assigned to the gas outlet section.

19. (canceled)

20. The apparatus of claim 1, wherein the gas outlet section of the at least one pressure pipe is provided with the at least one double-walled section of the at least one pressure pipe.

21. The apparatus of claim 1, further comprising a dampening device connectable or connected to the gas outlet section and configured to dampen a pressurized gas stream exiting the at least one pressure pipe through the gas outlet section.

22. The apparatus of claim 1, further comprising a heating device configured to heat the particle processing volume of the at least one pressure pipe, wherein the heating device is configured to generate a plurality of temperature zones having different temperatures within the particle processing volume.

23. (canceled)

24. The apparatus of claim 22, further comprising a control unit to control operation of the heating device, the control unit being configured to control operation of the heating device such that a constant temperature or a constant temperature profile is provided inside the at least one pressure pipe.

25. The apparatus of claim 1, wherein the apparatus is operable in a plurality of operating modes comprising at least one of: a filling mode in which the particle processing volume is fillable or filled with polymer particles which are to be pressurized to adjust or generate the expansion capability, a pressurizing mode in which the particle processing volume is pressurized, a de-filling mode in which pressurized polymer particles are removed from the particle processing volume, and a cleaning mode in which the particle processing volume is cleaned from residues by a stream of cleaning fluid.

26. (canceled)

27. (canceled)

28. (canceled)

29. (canceled)

30. The apparatus of claim 1, wherein the at least one pressure pipe is vertically arranged or arranged inclined relative to a horizontal axis.

31. The apparatus of claim 1, wherein the apparatus comprises a plurality of pressure pipes, wherein the plurality of pressure pipes are at least partially arranged in parallel.

32. (canceled)

33. (canceled)

34. (canceled)

35. A method for pressurizing polymer particles with gas to generate a specific expansion behavior or expansion capability, wherein the method is carried out with the apparatus of claim 1 and comprises filling the particle processing volume of at least one pressure pipe with polymer particles and pressurizing the polymer particles in the particle processing volume for a specific time so as to obtain pressurized polymer particles having a specific expansion capability.
